(19) United States
(12) Patent Application Publication
(10) Pub. No.: US 2009/0303275 A1
(43) Pub. Date: Dec. 10, 2009

(54) DROPLET DISCHARGE DEVICE, METHOD FOR DISCHARGING DROPLET AND METHOD FOR MANUFACTURING ELECTRO-OPTICAL DEVICE

(75) Inventors: Tatsuya Ito, Shiojiri (JP); Yuji Iwata, Suwa (JP); Osamu Kasuga, Suwa (JP)

Correspondence Address: GLOBAL IP COUNSELORS, LLP, 1233 20TH STREET, NW, SUITE 700, WASHINGTON, DC, 20036-2680, US

(73) Assignee: SEIKO EPSON CORPORATION, Tokyo (JP)

(21) Appl. No.: 12/474,845

(22) Filed: May 29, 2009

(30) Foreign Application Priority Data
Jun. 4, 2008 (JP) 2008-146675

(51) Int. Cl. B41J 29/38

(52) U.S. Cl. 347/17

(57) ABSTRACT

A droplet discharge device includes: a discharge unit discharging a droplet; an information obtaining unit obtaining workload information of the discharge unit while a predetermined pattern is formed on a discharged object; a temperature calculation unit calculating a prediction temperature of the discharge unit while the pattern is formed based on the workload information obtained by the information obtaining unit; and a temperature control unit controlling a temperature of the discharge unit at the prediction temperature calculated by the temperature calculation unit. In the device, the discharge unit and the discharged object of the droplet are relatively moved so as to form the predetermined pattern on the discharged object.

### BACKGROUND

1. Technical Field

The present invention relates to a droplet discharge device including a nozzle group that discharges a droplet by an electrical driving signal, and a method for discharging a droplet and a method for manufacturing an electro-optical device.

2. Related Art

A droplet discharge device is used for, for example, color filters of liquid crystal displays and a field of film formation such as a function film of organic electro-luminescence (EL) devices. The droplet discharge device includes a droplet discharge mechanism called a droplet discharge head. The droplet discharge head includes a plurality of nozzles formed regularly. In the droplet discharge device, a droplet including a functional material is discharged from the nozzles as a droplet so as to form a pattern made of the droplet on a discharged object composed of a substrate and the like.

In recent years, image quality and fineness of displays have been improved, and precision of a pattern to be formed have become important. In order to improve the precision of the pattern, controlling an amount of the droplet discharged from the droplet discharge head becomes important. A characteristic such as a viscosity of the droplet including a functional material varies in accordance with a temperature. In the droplet discharge device, if the characteristic of the droplet varies, a discharge characteristic of the droplet discharged from the droplet discharge head varies. Accordingly, the discharge amount may vary. Thus, a droplet discharge system is proposed such that a droplet discharge device is provided in a chamber so that a temperature of an atmosphere is maintained substantially constant and a discharge amount is measured, controlling the discharge amount based on its measurement result. JP-A-2004-209429 is an example of related art that discloses such a droplet discharge system.

A droplet discharge device includes a variety of driving sources that drive the droplet discharge device. Most of the driving sources become a heat source and emit heat, causing a temperature variation of the droplet discharge device. For example, in regard to a piezoelectric element that drives a droplet discharge head, part of energy applied to the piezoelectric element is converted into heat, causing a rise of a temperature of the droplet discharge head. The rise of the temperature depends on a frequency that the piezoelectric element is driven, in other words, a discharge frequency that the droplet is discharged. That is, each nozzle group including a nozzle assigned corresponding to a pattern to be formed may have difference in the rise of temperature.

The droplet discharge system described above has possibilities that each droplet discharge head or nozzle has difference in the rise of temperature depending on the discharge frequency even the temperature of the atmosphere is maintained substantially constant. A variation in temperature for each nozzle group causes a variation in discharge amount for each nozzle group. As a result, the pattern to be formed may include unevenness occurred by a difference of the discharge amount of the droplet. If a color filter of a liquid crystal display and the like and a thin film (a pattern) of a function film and the like of an organic EL device include unevenness, image quality of manufactured display is degraded.

### SUMMARY

An advantage of the invention is to solve at least part of the above-described problem, and can be realized by the following aspects.

According to a first aspect of the invention, a droplet discharge device includes: a discharge unit discharging a droplet; an information obtaining unit obtaining workload information of the discharge unit while a predetermined pattern is formed on a discharged object; a temperature calculation unit calculating a prediction temperature of the discharge unit while the pattern is formed based on the workload information obtained by the information obtaining unit; and a temperature control unit controlling a temperature of the discharge unit to the prediction temperature calculated by the temperature calculation unit. In the device, the discharge unit and the discharged object of the droplet are relatively moved so as to form the predetermined pattern on the discharged object.

A droplet discharge head and a nozzle group serving as a discharge unit has a different workload and a temperature variation depending on a pattern to be formed. In addition, a characteristic of the droplet discharged from the discharge unit varies in accordance with a temperature. If the characteristic of the droplet varies, a discharge characteristic of the discharge unit varies, resulting in varying a discharge amount. However, after continuously discharging the droplet at a certain discharge ratio, the droplet discharge head and the nozzle group serving as a discharge unit reach to a substantially constant temperature and become thermally stable. Then, the temperature is maintained.

With this structure, the droplet discharge device can obtain a workload of the discharge unit as information when the predetermined pattern is formed, and a temperature that the discharge device reaches and becomes substantially stable when the pattern is formed can be calculated as a prediction temperature based on the workload. Then, by the temperature control unit, a temperature of the discharge unit can be controlled at the prediction temperature. Accordingly, a temperature of the discharge unit can be controlled at the substantially stable temperature since the beginning of a discharge operation, and a temperature variation can be reduced, so that a variation of the discharge amount of the droplet can be reduced. As a result, a variation of the amount of the droplet discharged on the discharged object can be reduced, and unevenness and a variation of a thickness of a pattern to be formed can be reduced. Therefore, a pattern (a thin film) in which unevenness and a variation are reduced can be formed.

The discharge unit may include a nozzle group discharging the droplet by an electrical driving signal and the temperature calculation unit calculates a substantially constant temperature that a temperature of the nozzle group reaches by discharging the droplet.

With this structure, the temperature control unit of the droplet discharge device can predict the substantially constant temperature that the nozzle group serving as a discharge unit reaches when the predetermined pattern is formed.

The information obtaining unit may obtain at least a discharge ratio at which the droplet is discharged from a nozzle group as information. In the device, the discharged object on which the pattern is formed and the nozzle group are relatively moved.

With this structure, the information obtaining unit of the droplet discharge device can obtain the discharge ratio as a workload of the nozzle group serving as a discharge unit when the predetermined pattern is formed.

The temperature control unit may be a driving control unit controlling a driving signal that discharges the droplet, and the driving signal of around a threshold size by which the droplet is not discharged from a nozzle group may be supplied to the nozzle group so as to control a temperature of the nozzle group that discharges the droplet.

With this structure, the temperature control unit uses the driving control unit that supplies a driving signal to the nozzle group for supplying the driving signal of around a threshold size by which the droplet is not discharged from the nozzle group to the nozzle group so as to control a temperature of the nozzle group. Therefore, the temperature of the nozzle group can be controlled without additional temperature control unit.

The temperature control unit may include a memory unit storing a plurality of driving signals corresponding to a discharge ratio of the pattern, and based on obtained information of the pattern, the driving signal corresponding to the pattern stored in the memory unit may be selected and supplied to a nozzle group. In the device, the droplet is discharged by the driving signal, and the discharge ration is a ratio at which the droplet is discharged from the nozzle group.

With this structure, the temperature control unit of the droplet discharge device, corresponding to the pattern (the discharge ratio) to be formed, can store the plurality of the driving signals for controlling a temperature in the storing unit in advance. Then, corresponding to the pattern to be formed by the nozzle group, the driving signal to be applied is selected out of the stored plurality of the driving signals and is supplies to the nozzle group, thereby the temperature can be controlled. Therefore, the temperature can be controlled for each nozzle group. As a result, a variation of the discharge amount of the droplet for each nozzle can be reduced.

The temperature control unit may perform a calculation based on an obtained discharge ratio of the pattern so that a driving signal corresponding to the pattern may be generated and supplied to a nozzle group. In the device, the discharge ratio is a ratio at which the droplet is discharged from the nozzle group, and the droplet is discharged by the driving signal.

With the structure, the temperature control unit of the droplet discharge device, corresponding to the pattern (the discharge ratio) to be formed, performs a calculation with respect to the base driving signal and generates the driving signal to be supplied. Then, the driving signal is supplied to the nozzle group so as to control a temperature. Therefore, a temperature can be controlled for each nozzle group. As a result, a variation of the discharge amount of the droplet for each nozzle can be reduced.

The temperature control unit may control a temperature of a nozzle group while the droplet is not discharged from the nozzle group.

With this structure, the temperature control unit of the droplet discharge device can control a temperature of the nozzle group when the droplet is not discharged from the nozzle group. Therefore, the temperature can be controlled without affecting a discharge operation of the droplet from the nozzle group.

The temperature control unit may control a temperature of a nozzle group before the droplet is started to be discharged from the nozzle group on the discharged object.

With this the structure, the temperature control unit of the droplet discharge device can control a temperature of the nozzle group at a substantially constant temperature when the droplet is discharged from the nozzle on the discharged object. Therefore, a variation of the droplet can be reduced since the beginning of a discharge operation of the droplet from the nozzle group.

According to a second aspect of the invention, a method for discharging a droplet in which a discharge unit discharging a droplet and a discharged object of the droplet are relatively moved so as to form a predetermined pattern on the discharged object includes: obtaining workload information of the discharge unit while the pattern is formed; calculating a prediction temperature of the discharge unit while the pattern is formed based on the obtained workload information obtained in the step of obtaining workload information; and controlling a temperature of the discharge unit at the prediction temperature calculated in the step of calculating a temperature.

With this method, a workload of the discharge unit can be obtained as information when the predetermined pattern is formed, and a temperature that the discharge unit reaches and becomes substantially stable when the pattern is formed can be calculated as a prediction temperature based on the workload. Then, the step of controlling a temperature allows controlling a temperature of the discharge unit at the prediction temperature. Accordingly, the temperature of the discharge unit can be controlled at the substantially stable temperature since the beginning of a discharge operation and a temperature variation can be reduced, so that a variation of the discharge amount of the droplet can be reduced. As a result, a variation of the amount of the droplet discharged on the discharged object can be reduced, and unevenness and a variation of a thickness of a pattern to be formed can be reduced. Therefore, a pattern (a thin film) in which unevenness and a variation are reduced can be formed.

The discharge unit may include a nozzle group discharging the droplet by an electrical driving signal, and in the step of calculating a temperature, a saturation temperature that a temperature of the nozzle group becomes substantially constant by discharging the droplet may be calculated as a prediction temperature.

With this method, in the step of calculating a temperature, a substantially constant temperature that the nozzle group serving as a discharge unit reaches when the predetermined pattern is formed can be predicted.

The step of obtaining information, the discharged object on which the pattern is formed and a nozzle group are relatively moved, at least a discharge ratio at which the droplet is discharged from the nozzle group may be obtained as information.

With this method, in the step of obtaining information, a discharge ratio as a workload of the nozzle group serving as a discharge device when the predetermined pattern is formed can be obtained.

In the step of controlling a temperature may include controlling a driving signal, and in the step of controlling a driving signal, the driving signal of around a threshold size by which the droplet is not discharged from a nozzle group may be supplied to the nozzle group. In the method, the droplet is discharged by the driving signal from the nozzle group.

With this method, in the step of controlling a temperature, the driving signal of around a threshold size by which the droplet is not discharged from the nozzle group is supplied to the nozzle group so as to control a temperature of the nozzle. Therefore, the temperature of the nozzle group can be controlled without additional temperature control unit.

In the step of controlling a temperature may include a memory unit storing a plurality of driving signals corresponding to a discharge ratio of the pattern, and the driving signal corresponding to the pattern stored in the memory unit may be selected and supplied to the nozzle group. In the method, the droplet is discharged by the driving signal, and the discharge ratio is a ratio at which the droplet is discharged from the nozzle group.

With this method, in the step of controlling a temperature, corresponding to the pattern (the discharge ratio) to be formed, the plurality of the driving signals for controlling a temperature can be stored in the storing unit in advance. Then, corresponding to the pattern to be formed by the nozzle group, the driving signal to be applied is selected out of the stored plurality of the driving signals and supplied to the nozzle group, thereby a temperature can be controlled. Therefore, the temperature can be controlled for each nozzle group. As a result, a variation of the discharge amount of the droplet for each nozzle can be reduced.

In the step of controlling a driving signal, based on an obtained discharge ratio of the pattern, a calculation may be performed so as to generate the driving signal corresponding to the pattern, and in the step of controlling a temperature, the driving signal generated in the step of controlling a driving signal may be supplied to a nozzle group. In the method, the droplet is discharged by the driving signal, and the discharge ratio is a ratio at which the droplet is discharged from the nozzle group.

With this method, in the step of controlling a driving signal, corresponding to the pattern (the discharge ratio) to be formed, a calculation is performed with respect to the base driving signal so as to generate the driving signal to be supplied. Then, in the step of controlling a temperature, the driving signal is supplied to the nozzle group so as to control a temperature. Therefore, the temperature can be controlled for each nozzle group. As a result, a variation of the discharge amount of the droplet for each nozzle can be reduced.

In the step of controlling a temperature, a temperature of a nozzle group may be controlled while the droplet is not discharged from the nozzle group.

With this method, in the step of controlling a temperature, a temperature can be controlled when the droplet is not discharged from the nozzle group. Therefore, a temperature can be controlled without affecting a discharge operation of the droplet from the nozzle group.

In the step of controlling a temperature, a temperature of a nozzle group may be controlled before the droplet is started to be discharged from the nozzle group on the discharged object.

With this method, in the step of controlling a temperature, a temperature of the nozzle group can be controlled at a substantially stable temperature when the droplet is discharged from the nozzle on the discharged object. Therefore, a variation of the droplet can be reduced since the beginning of a discharge operation of the droplet from the nozzle group.

According to a third aspect of the invention, a method for manufacturing an electro-optical device including an electro-optical panel having a plurality of color element regions partitioned by a partition disposed on at least one of substrates includes: discharging a plurality of kinds of liquid bodies including: a color element region formation material on the plurality of the color element regions on the substrate by applying the droplet discharge described above or the method for discharging a droplet described above; and drying the drawn color element to form a film.

With this method, in the step of drawing a color element, by applying the droplet discharge device or the method for discharging a droplet described above, the plurality of kinds of the liquid bodies including a color element region formation material can be discharged and drawn on the plurality of the color element regions on the substrate with reduced variation of the discharge amount. Then, in the step of forming a film, the drawn color element is dried so as to form a film. Therefore, an electro-optical device having high display quality with less unevenness of a film thickness can be manufactured.

### BRIEF DESCRIPTION OF THE DRAWINGS

The invention will be described with reference to the accompanying drawings, wherein like numbers reference like elements.

FIG. 1 is a perspective view schematically showing a structure of a droplet discharge device.

FIGS. 2A and 2B are views schematically showing a structure of a droplet discharging head.

FIG. 3 is a plan view schematically showing an arrangement of the droplet discharging head.

FIG. 4 is a block diagram showing a control system of the droplet discharge device.

FIG. 5 is a block diagram showing an electrical control of the droplet discharge head.

FIG. 6 is a timing diagram of a driving signal and a control signal.

FIG. 7 is a view showing a relation of the droplet discharge head and a workpiece.

FIG. 8 is a flowchart explaining a method for discharging a droplet.

FIGS. 9A, 9B, and 9C are views explaining a method for setting a temperature condition.

FIGS. 10A, 10B, and 10C are views explaining a method for fine-adjusting a driving voltage.

FIG. 11 is an exploded perspective view schematically showing a structure of a liquid crystal display.

FIG. 12 is a flowchart showing a method for manufacturing a liquid crystal display.

FIGS. 13A, 13B, 13C, 13D, and 13E are sectional views schematically showing the method for manufacturing a liquid crystal display.

FIG. 14 is a sectional view schematically showing an essential part of an organic EL display.

FIG. 15 is a flowchart showing a method for manufacturing an organic EL display.

FIGS. 16A, 16B, 16C, 16D, 16E, and 16F are sectional views schematically showing the method for manufacturing an organic EL display.

### DESCRIPTION OF EXEMPLARY EMBODIMENTS

Embodiments of the invention in which a color filter including a color layer is manufactured with a droplet discharge device will be explained. Note that scales of members in the drawings referred to hereinafter are adequately changed for expository convenience.

### First Embodiment

Structure of Droplet Discharge Device

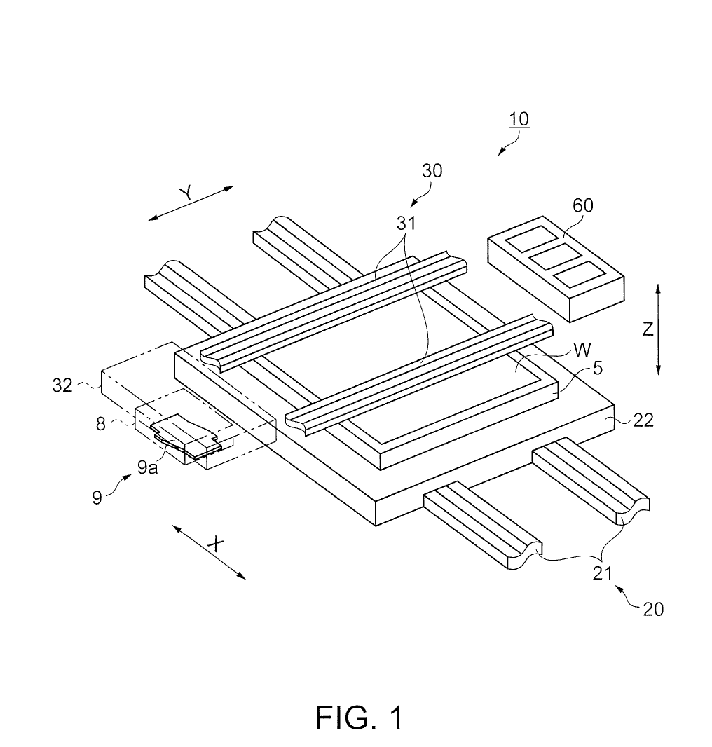

First, a droplet discharge device including a droplet discharge head discharging a droplet as a droplet will be described with reference to FIG. 1. FIG. 1 is a perspective view schematically showing a structure of the droplet discharge device. As shown in FIG. 1, a droplet discharge device 10 includes a workpiece moving mechanism 20 for moving a workpiece W as a discharged object in a main scanning direction and a head moving mechanism 30 for moving a head unit 9 including a plurality of droplet discharge heads in a sub scanning direction. The droplet discharge device 10 changes a relative position of the workpiece W and the head unit 9 while the droplet is discharged as a droplet from the plurality of the droplet discharge heads provided to the head unit 9 so as to form a predetermined pattern on the workpiece W with the droplet. In addition, an X direction in the drawing indicates a moving direction of the workpiece W, that is the main scanning direction, a Y direction indicates a moving direction of the head unit 9, that is the sub scanning direction, and a Z direction indicates a direction that the X direction and the Y direction are perpendicular to each other.

The droplet discharge device 10, for example, can be applied for manufacturing a color filter that makes a color display of various kinds of displays possible. For example, when a color filter having filter elements of three colors, red, green, and blue is manufactured, any one of liquid bodies of three colors, red, green, and blue is discharged from the respective droplet discharge heads of the droplet discharge device 10 on the workpiece W as a droplet so as to form a patter of the filter elements of the three colors, red, green, and blue.

Here, each structure of the droplet discharge device 10 will be described. The workpiece moving mechanism 20 includes a pair of guide rails 21, a moving stage 22 moving along the pair of the guide rails 21, and a stage 5 for placing the workpiece W sucked and fixed to the moving stage 22. The moving stage 22 is moved in the X direction (the main scanning direction) by an air slider and a linear motor which are not shown disposed inside the guide rails 21.

The head moving mechanism 30 includes a pair of guide rails 31 and a moving stage 32 moving along the pair of guide rails 31. The moving stage 32 includes carriage 8. The carriage 8 includes a head unit 9 including a plurality of droplet discharge heads 50 provided thereto. Then, the moving stage 32 moves the carriage 8 in the Y direction (the sub scanning direction) such that the head unit 9 is arranged in a position opposed to the workpiece W with a predetermined space in the Z direction.

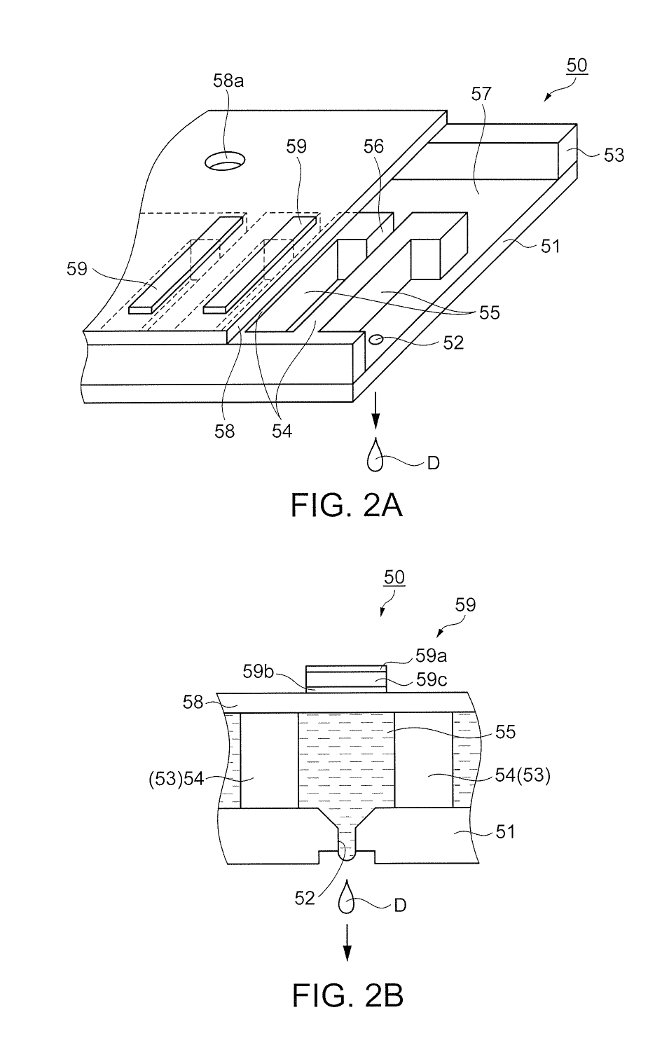

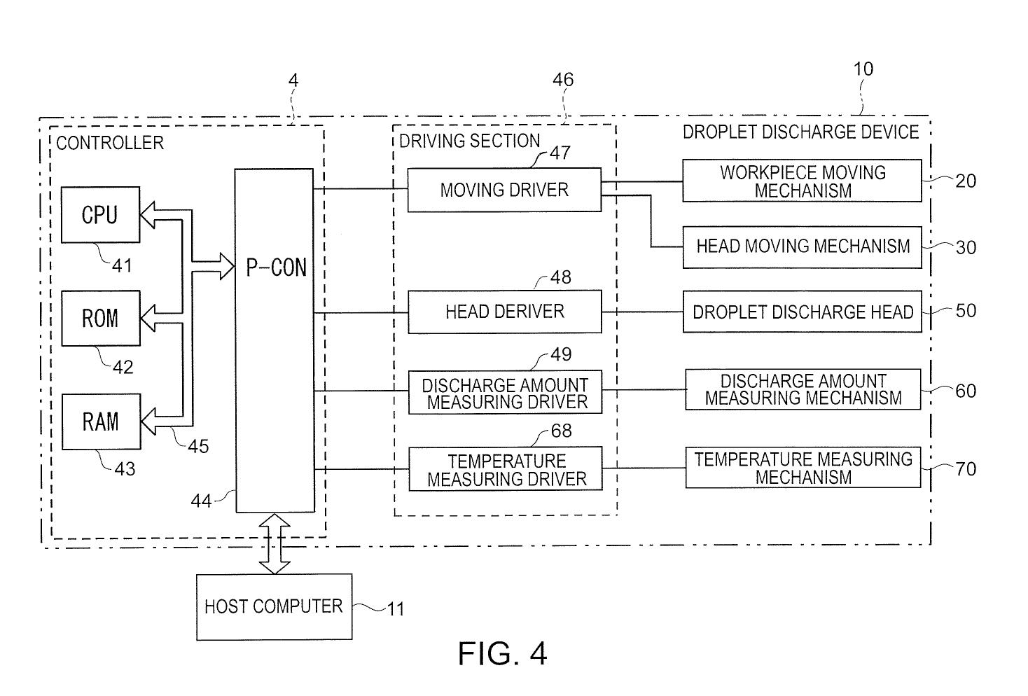

The droplet discharge device 10 includes a discharge amount measuring mechanism 60 that includes measuring equipment such as an electronic balance. The discharge amount measuring mechanism 60 receives the droplet discharged from each droplet discharge head 50 or each nozzle to measure the weight of the discharged amount. The droplet discharge device 10 includes a temperature measuring mechanism 70 (refer to FIG. 4) that detects a temperature of the droplet discharge head 50. The temperature measuring mechanism 70 may measure a temperate of the droplet discharge head with a thermocouple provided to the droplet discharge head, for example, or a peripheral temperate of where the droplet is discharged, for example, a nozzle plate 51 (refer to FIG. 2) by applying a contactless infrared rays temperature detecting device of contactless.

Additionally, the droplet discharge device 10, other than the structure described above, further includes a droplet supply mechanism for supplying the droplet discharge heads 50 with the droplet and a maintenance mechanism for performing elimination of the clogging of the nozzle of the plurality of the droplet discharge heads 50 provided to the head unit 9. Each of the mechanism is controlled by a controller 4 (refer to FIG. 4). In FIG. 1, the controller 4, the temperature measuring mechanism 70, the droplet supply mechanism, and the maintenance mechanism are not shown.

Droplet Discharge Head

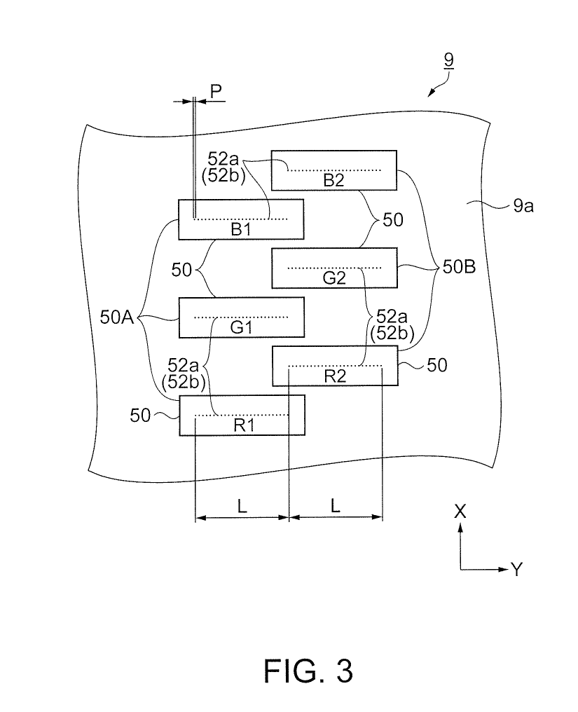

Here, the droplet discharge head including the nozzle group as a discharge unit will be described with reference to FIGS. 2 and 3. FIGS. 2A and 2B are views schematically showing a structure of the droplet discharge head. FIG. 2A is an exploded perspective view and FIG. 2B is a sectional view schematically showing a structure of a nozzle unit. FIG. 3 is a plan view schematically showing an arrangement of the droplet discharge head in the head unit. Specifically, it is the drawing viewed from a side opposite to the workpiece W. In addition, the X direction and the Y direction shown in FIG. 3 indicate the same direction as the X direction and the Y direction shown in FIG. 1.

As shown in FIGS. 2A and 2B, the droplet discharge head 50 is structured by sequentially laminating and bonding a nozzle plate 51 including a plurality of nozzles 52 discharging liquid droplets D, a cavity plate 53 including a partition wall 54 partitioning a cavity 55 that communicates with each nozzle 52, and an vibration plate 58 including a resonator 59 as a driving element corresponding to each cavity 55.

The cavity plate 53 has the partition wall 54 partitioning the cavity 55 communicating with the nozzle 52 and flow paths 56 and 57 for filling the cavity 55 with the droplet. The flow path 57 is sandwiched by the nozzle plate 51 and the vibration plate 58, whereby a space serving as a reservoir for reserving the droplet is formed. The droplet is supplied from the droplet supply mechanism through a piping to be reserved in the reservoir through a supply hole 58a formed in the vibration plate 58, and then is filled in each cavity 55 through the flow path 56.

As shown in FIG. 2B, the resonator 59 is a piezoelectric element composed of a piezo element 59c and a pair of electrodes 59a and 59b sandwiching the piezo element 59c therebetween. A driving waveform as a driving signal is externally applied to the pair of electrodes 59a and 59b to deform the bonded vibration plate 58. Consequently, a volume of the cavity 55 partitioned by the partition wall 54 is increased and thereby the droplet is drawn into the cavity 55 from the reservoir. Then, after the application of the driving waveform, the vibration plate 58 returns to its original shape and pressurizes the filled droplet. As a result, the droplet can be discharged as a droplets D from the nozzle 52. Controlling the driving waveform applied to the piezo element 59c allows controlling a discharge of the droplet of each nozzle 52.

In addition, a driving waveform of around a threshold size by which the droplet is not discharged from the nozzle 52 is applied to the piezo element 59c so that the droplet in the cavity 55 is vibrated. Accordingly, an increase of a viscosity of the droplet accumulating in the cavity 55 can be reduced and a meniscus of a droplet discharge orifice of the nozzle 52 can be optimally maintained. Further, by using a conversion of part of energy of the driving waveform applied to the piezo element 59c into heat, a temperature of the droplet discharge head 50 can be controlled.

As shown in FIG. 3, the droplet discharge head 50 described above is disposed to a head plate 9a of the head unit 9. On the head plate 9a, a total of six droplet discharge heads 50 including a head group 50A composed of three droplet discharge heads 50 and a head group 50B similarly composed of three droplet discharge heads 50 are provided. In this case, the droplet discharge head 50 of the head group 50A (a head R1) discharges the same kind of droplet as that discharged from the droplet discharge head 50 of the head group 50B (a head R2). The other heads G1, G2 and B1, B2, respectively, are also the same as above. That is, the head unit 9 is structured to discharge three different kinds of liquid bodies.

Each droplet discharge head 50 includes a nozzle line 52a that is composed of a plurality (180) of nozzles 52 arranged at a predetermined pitch P. Accordingly, each droplet discharge head 50 has a discharge width, a length L. In addition, the plurality of the nozzles 52 composing the nozzle line 52a has the flow path shown in FIG. 2 in common and composes a single nozzle group 52b in the embodiment. The heads R1 and R2 are juxtaposed in the main scanning direction in such a manner that the nozzle lines 52a adjacent when viewed from the main scanning direction (the X direction) are continuously arranged with a single pitch P therebetween in the sub scanning direction (the Y direction) orthogonal to the main scanning direction. Accordingly, the heads R1 and R2 form the discharge width of the length 2L.

In the embodiment, the nozzle line 52a is a single line. However, it is not particularly limited to this. The droplet discharge head 50 may be arranged in a manner such that a plurality of nozzle lines 52a is arranged with a certain interval in the X direction and a ½ pitch (P/2) therebetween in the Y direction. Accordingly, the substantial pitch P becomes narrower, and the droplet D can be discharged with high accuracy.

Control System of Droplet Discharge Device

Next, a control system of the droplet discharge device 10 will be described with reference to FIG. 4. FIG. 4 is a block diagram showing the control system of the droplet discharging device. As FIG. 4 shows, the control system of the droplet discharge device 10 includes a driving section 46 having various kinds of drivers for driving the droplet discharge head 50, the workpiece moving mechanism 20, the head moving mechanism 30, and the like, and the controller 4 for controlling the droplet discharge device 10 including the driving section 46. The driving section 46 includes a moving driver 47 performing a drive control of each linear motor of the workpiece moving mechanism 20 and the head moving mechanism 30, a head driver 48 controlling a discharge of the droplet discharge heads 50, a temperature measuring driver 68 controlling the temperature measuring mechanism 70 that detects a temperature of the droplet discharge head 50, a discharge amount measuring driver 49 controlling the discharge amount measuring mechanism 60, and a maintenance driver (not shown) performing a drive control of each maintenance unit of the maintenance mechanism.

The controller 4 includes a CPU 41, a ROM 42, a RAM 43, and a P-CON 44, and these are coupled to each other through a bus 45. A host computer 11 is coupled to the P-CON 44. The ROM 42 includes a control program region for storing a control program and the like processed by the CPU 41 and a control data region for storing control data and the like used to perform a drawing operation, a function recovery processing, and the like.

The RAM 43 has various kinds of storage sections such as a pattern data storage section storing pattern data used to draw patterns on the workpiece W, and is used as various kinds of work regions for a control processing. The P-CON 44 is coupled to the various drivers and the like of the drive section 46 to cover the functions of the CPU 41. Additionally, the P-CON 44 has a logic circuit formed and incorporated therein to handle interface signals between the CPU and a peripheral circuit. Therefore, the P-CON 44 takes various kinds of instructions from the host computer 11 in the bus 45 directly or with modification, and in conjunction with the CPU 41, the P-CON 44 outputs the data and the control signals which are outputted from the CPU 41 and the like to the bus 45 to the driving section 46 directly or with modification.

Further, along the control program in the ROM 42, the CPU 41 inputs various kinds of detection signals, various kinds of commands, various kinds of data, and the like through the P-CON 44, processes the various kinds of data and the like in the RAM 43, and then outputs various kinds of control signals to the driving section 46 and the like through the P-CON 44, thereby controlling the entire droplet discharge device 10. For example, the CPU 41 controls the droplet discharge head 50, the workpiece moving mechanism 20, and the head moving mechanism 30 so that the head unit 9 and the workpiece W are placed opposite to each other. Then, in synchronization with a relative movement of the head unit 9 and the workpiece W, the droplet is discharged as a droplet D from the plurality of the nozzles 52 of each droplet discharge head 50 included to the head unit 9 so as to form a pattern on the workpiece W. In this case, discharging the droplet in synchronization with the movement of the workpiece W in the X direction is referred to as main scanning, whereas moving the head unit 9 in the Y direction is referred to as sub scanning. The droplet discharge device 10 of the embodiment allows discharging the droplet through a plurality of times of repetition of a combination of the main scanning and the sub scanning. The main scanning is not limited to the movement of the workpiece W in a single direction with respect to the droplet discharge heads 50. The main scanning may also be performed by reciprocating the workpiece W.

Not only outputting control information such as the control program and the control data to the droplet discharge device 10, but the host computer 11 can also modify these control information. In addition, based on nozzle information of the nozzle 52 (for example, position information of the nozzle 52 and the like), the host computer 11 also has functions as an arrangement information generating section that generates arrangement information for arranging the required amount of the droplet as a droplet D for each discharged region on a substrate. The arrangement information is such that a discharge position of the droplet D in the discharge region (in other words, a relative position of the workpiece W and the nozzle 52), the arrangement number of the liquid D (in other words, the number of discharge times and a discharge ratio), an on/off of the plurality of the nozzles 52 in the main scanning, and discharge timing and the like represented as a bitmap, for example.

Drive Control of Droplet Discharge Head

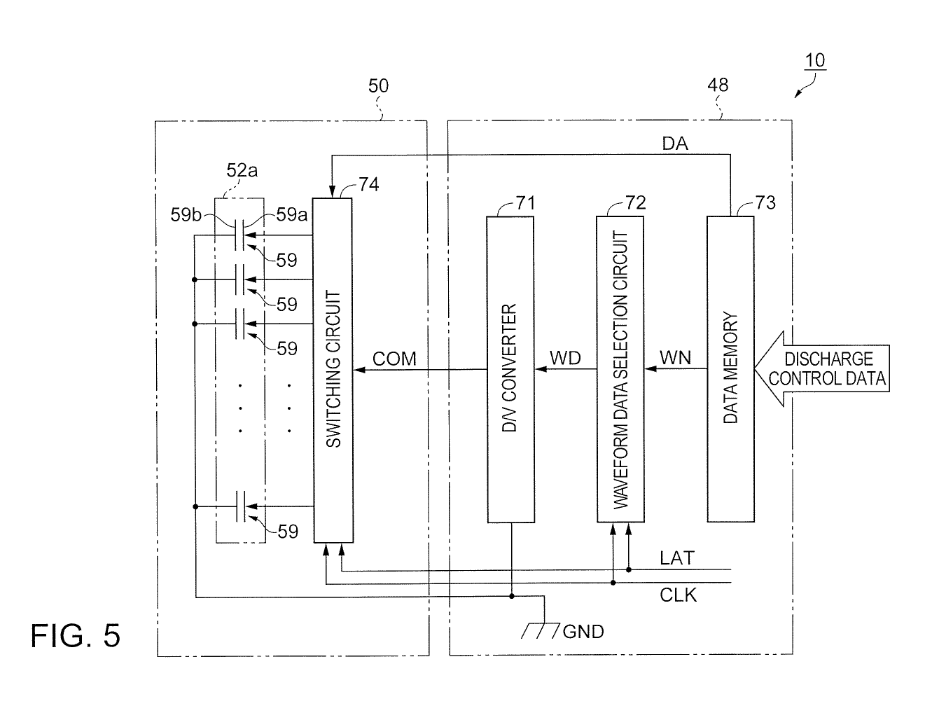

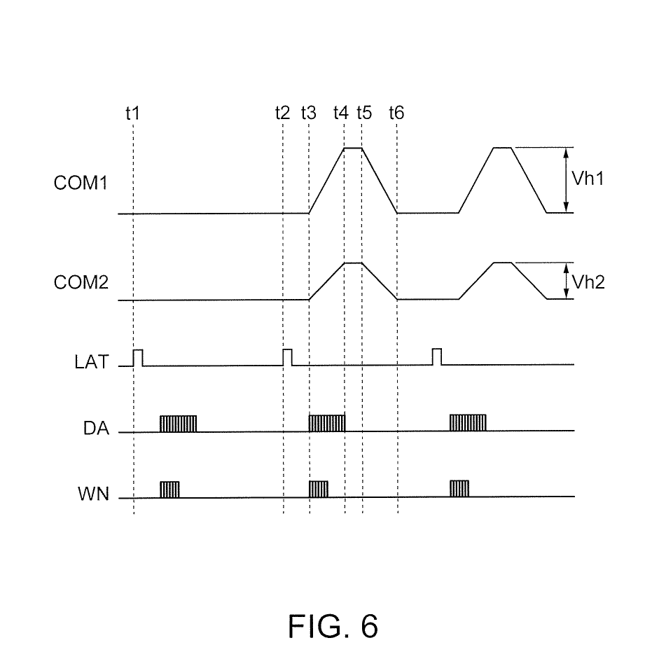

Next, the drive control of the droplet discharge head will be described with reference to FIGS. 5 to 6. FIG. 5 is a block diagram showing an electrical control of the droplet discharge head. FIG. 6 is a timing diagram of a driving signal and a control signal. As shown in FIG. 5, the head driver 48 includes a DIV converter (hereafter, referred to as a DAC) 71 generating a driving signal COM for controlling the droplet discharge head 50, a waveform data selection circuit 72 internally includes a storage memory for slew rate data (hereafter, referred to as wave data WD) of the driving signal COM generated in the DAC 71, a data memory 73 for storing discharge control data transmitted from the host computer 11 through the P-CON 44 (refer to FIG. 4). The driving signal COM generated in the DAC is respectively outputted to a COM line.

Each droplet discharge head 50 includes a switching circuit 74 that turns on/off of an application of the driving signal COM to the resonator 59 provided to each nozzle 52. In the nozzle 52, the electrode 59b, one of the electrodes of the resonator 59, is coupled to a ground line (GND) of the DAC 71. In addition, the electrode 59a (hereafter, referred to as a segment electrode 59a), another electrodes of the resonator 59, is electrically coupled to the COM line through the switching circuit 74. Further, a clock signal (CLK) and a latch signal (LAT) corresponding to each discharge are inputted to the switching circuit 74 and the waveform data selection circuit 72. The data memory 73 stores discharge data DA that defines the application (on/off) of the driving signal COM to each resonator 59 at each driving of the droplet discharge head 50 and waveform number data WN that defines the types of waveform data WD inputted to the DAC 71.

In the structure described above, the drive-control related to each discharge will be performed as follow. As shown in FIG. 6, in a period from timing t1 to timing t2, the discharge data DA and the waveform number data WN are respectively converted into a serial signal, and transmitted to the switching circuit 74 and the waveform data selection circuit 72. Then, each data is lathed at the timing t2 so that the segment electrode 59a of each resonator 59 related to the discharge (ON) becomes in a state of being coupled to the COM line. The waveform data WD of the driving signal related to generation of the DAC 71 is set.

In a period of timing t3 to timing t4, in accordance with the waveform data WD set at the timing t2, the driving signal COM is generated in a sequence of step of a potential rise, a potential retention, and a potential drop. Then, the generated driving signal COM is supplied to the resonator 59 which is in the condition of being coupled to the COM line so as to perform a volume (pressure) control of the cavity 55 communicating with the nozzle 52. Here, a potential rise component at the timing t3 expands the cavity 55, and plays a role of drawing the droplet into the cavity 55. In addition, a potential drop component at the timing t4 contracts the cavity 55, and plays a role of pushing the droplet to outside to discharge it.

A time component and a voltage component required for the potential rise, the potential retention, and the potential drop of the driving signal COM closely depends on a discharge amount of the droplet discharged by the supply. Especially, in the droplet discharge head 50 of a piezoelectric method, since the discharge amount shows a good linearity with respect to a variation of the voltage component, a variation of the voltage component (a potential difference) at the time from the timing t3 to the timing t4 is defined as a driving voltage Vh, and this can be used as a condition for controlling the droplet discharge head 50. That is, the driving voltage Vh is one of the conditions of the driving signal COM that controls a temperature control unit of the invention. Additionally, the driving signal COM to be generated is not particularly limited to a simple square wave shown in the embodiment. However, various shapes of waveforms such as a waveform of a trapezoid can be adequately employed, for example. Further, a pulse width (a time component) of the driving signal can be also used as a condition of the temperature control unit.

In the embodiment, a plurality of kinds of the waveform data WD that the driving voltage Vh thereof is different from each other in steps is prepared. Each independent waveform data WD is inputted to the DAC 71 so that the driving signal COM of the different driving voltage Vh can be respectively outputted to the COM line. For example, a driving signal COM1 including a driving voltage Vh1 and a driving signal COM 2 including a driving voltage Vh2 can be selected and outputted. A potential difference of the driving voltage Vh2 is smaller than that of the driving voltage Vh1. In addition, the waveform data WD that can be prepared is controlled by the waveform number data WN.

Thus, the droplet discharge device 10 of the embodiment can discharge the droplet by controlling the discharge amount of the droplet D by adequately setting the waveform number data WN that defines a corresponding relation of the kinds (the driving voltage Vh) of the driving signal for each nozzle 52. Further, in the droplet discharge device 10 of the embodiment, by applying the driving signal to the piezo element 59c, part of energy of the driving signal is converted into heat without discharging the droplet so as to control a temperature of the droplet discharge head 50. The driving signal applied to the piezo element 59 is set to the driving voltage Vh of around a threshold size by which the droplet is not discharged from the nozzle 52.

Method for Discharging Droplet

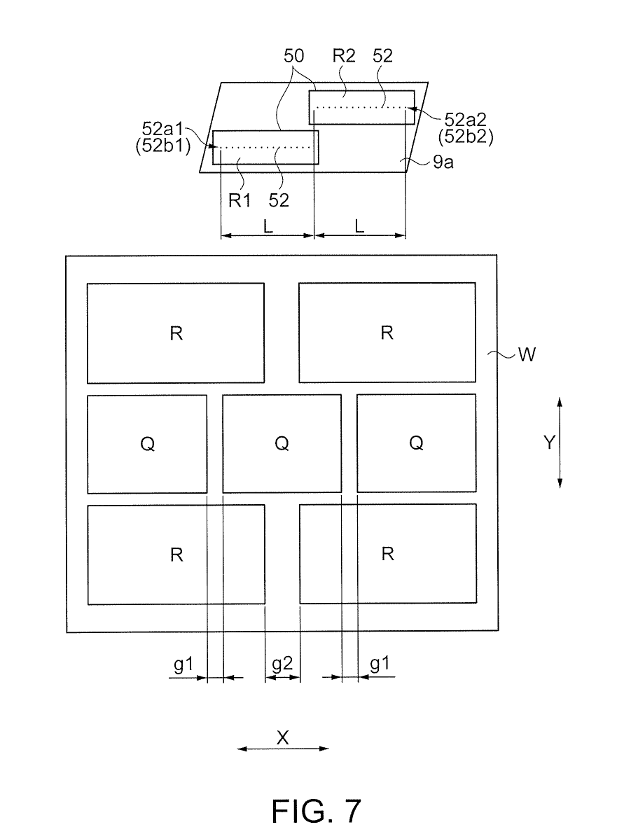

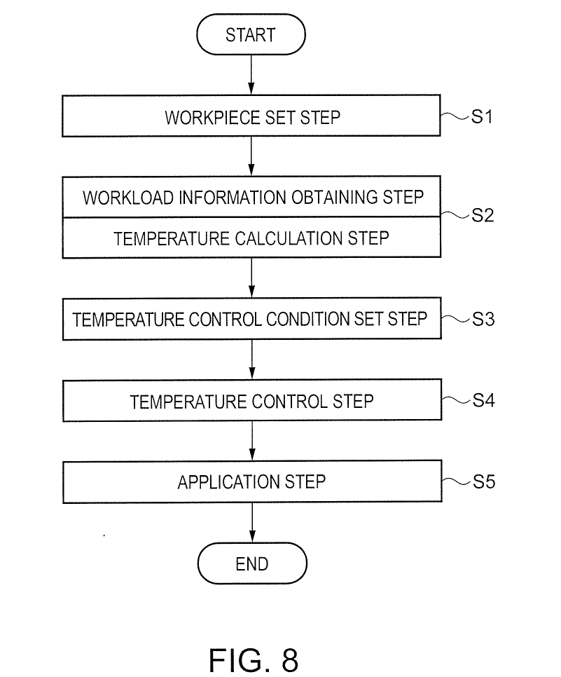

Next, a method for discharging a droplet will be described with reference to FIGS. 7 to 8. FIGS. 7 is a diagram showing a relation of the droplet discharge head and the workpiece. FIG. 8 is a flowchart describing the method for discharging a droplet.

As shown in FIG. 7, the plurality of the droplet discharge heads 50 provided to the head plate 9a includes a discharge width L that the droplet is discharged from the nozzle 52. In the whole head plate 9a, each discharge width L of the nozzle line 52a of each droplet discharge head 50 is added so as to form a single drawing line (2×L). In FIG. 7, a size of the droplet discharge head 50 is enlarged and the number of the droplet discharge head 50 is reduced to simplify the explanation. In addition, the X direction and the Y direction shown in FIG. 7 indicate the same direction as the X direction and the Y direction shown in FIG. 1.

The workpiece W serving as a discharged object includes two kinds of discharged regions, four first discharged regions R and three discharged regions Q. The discharged regions R and Q are different from each other in size. The second discharged regions Q of a smaller size are formed in a square and arranged in a center of the workpiece W in the Y direction with a predetermined interval g1 along the X direction. The first discharged regions R of a bigger size are formed in a rectangular and two discharged regions R are respectively arranged in the Y direction above and below the arranged second discharged regions with a predetermined interval g2 along the X direction. That is, on the workpiece W, a pattern including four first discharged regions R and three second discharged regions Q is provided.

Then, the droplet discharge head 50 is disposed by the head moving mechanism 30 shown in FIG. 1 such that the nozzle 52 is opposed to the pattern of the workpiece W. Then, while the workpiece W is moved in the X direction by the workpiece moving mechanism 20 also shown in FIG. 1, the droplet is discharged from the droplet discharge head 50 and the droplet is applied on the first discharged region R and the second discharged region Q.

At this time, as shown in FIG. 7, a nozzle line 52a1 of the head R1 includes two intervals g2 within the discharge width L while a nozzle line 52a2 of the head R2 includes one interval g1. Therefore, the nozzle line 52a of the droplet discharge head 50, that is a nozzle group 52b is focused, the number of discharge times of a nozzle group 52b1 is less than that of a nozzle group 52b2. In other word, in a single discharge operation in the main scanning direction, a discharge ratio (the number of discharge times per unit time) of the nozzle group 52b1 is smaller than that of the nozzle group 52b2.

As described above, since part of energy of the driving waveform applied to the piezo element 59c is converts into heat, a temperature of the droplet discharge head 50 varies. In addition, a characteristic such as a viscosity of the droplet including a functional material varies in accordance with the temperature. As a result, a discharge characteristic of the droplet discharged from the droplet discharge head 50 varies and thereby the discharge amount also varies. Therefore, the heads R1 and R2 have a temperature variation due to a difference in the discharge ratio of the main scanning direction while drawing. Accordingly, the discharge amount of the droplet varies in the main scanning direction and the discharge amount of the droplet may be different due to different slopes of the temperature variation of the heads R1 and R2 in the sub scanning direction. The method for discharging a droplet of the embodiment is such that the temperature of the droplet discharge head 50 is controlled at a predetermined temperature when the droplet discharge head 50 starts drawing a pattern so as to reduce a variation of the discharge amount while drawing.

In a workpiece set step of a step S1 shown in FIG. 8, the workpiece W described above is set on the stage 5 of the droplet discharge device 10. At this time, as shown in FIG. 7, in accordance with a layout of the pattern formed on the workpiece W, the droplet discharge head 50 for discharging the droplet is assigned. Next, in a workload information obtaining step of a step S2, a discharge ratio serving as a workload of the assigned droplet discharge head 50 is obtained. The discharge ratio is calculated from the bitmap data described above. The discharge ratio may be obtained by the host computer 11 shown in FIG. 4 or the controller 4 of the droplet discharge device 10. In this case, the controller 4 and the like correspond to an information obtaining unit.

In addition, in a temperature calculation step also in the step S2, a prediction temperature that the droplet discharge head 50 is controlled is calculated. The prediction temperature is preferably a substantially constant temperature obtained by continuously discharging the droplet by the droplet discharge head 50, that is a saturation temperature of the droplet discharge head 50. Each droplet discharge head 50 may have a specific saturation temperature according to components composing the droplet discharge head 50 and a position that the droplet discharge head 50 is disposed. The saturation temperature is preferably obtained by discharging the droplet for a certain period of time before the drawing operation. The saturation temperature is also calculated by a method for setting a temperature control condition described later. As for a temperature of the droplet discharge head 50, by using the temperature measuring mechanism 70 shown in FIG. 4, part of the droplet discharge head 50 is measured where a variation of the temperature thereof can be measured by relating to the droplet discharged from the droplet discharge head 50. For example, any temperature of an outer wall surface of the droplet discharge head 50, the nozzle plate 51 shown in FIG. 2, part of the vibration plate 58 where the cavity 55 is composed, and the like can be used.

The temperature of the outer wall surface of the droplet discharge head 50 and that of an outer wall of the cavity 55 of the vibration plate 58 can be measured with a head temperature sensor provided thereto. The cavity 55 of the vibration plate 58 can also be measured with a piezoelectric material composing the resonator 59 as a temperature sensor. The temperature of the outer wall surface of the droplet discharge head 50 and that of the nozzle plate 51 also can be measured from a distant position with a contactless infrared rays temperature sensor. The saturation temperature as a prediction temperature is stored in the RAM 43 of the controller 4.

Next, in a temperature adjustment condition set step of a step S3 shown in FIG. 8, an optimum driving condition is selected out of a plurality of driving conditions stored in the RAM 43 of the controller 4 so as to use it. The plurality of the driving conditions is obtained in advance for each discharge ratio corresponding to the saturation temperature to be reached. In addition, a setting of the driving condition at this time will be described later. Next, in a temperature adjustment step of a step S4, the selected temperature control condition (a driving condition), that is a driving waveform of around a threshold size by which the droplet is not discharged from the nozzle 52 is applied to the piezo element 59c so that part of energy of the driving waveform applied to the piezo element 59c is converted into heat. Then, a temperature of the droplet discharge head 50 is controlled to be closed at the saturation temperature before the drawing step.

Next, in an application step of a step S5, the droplet is discharged from the droplet discharge head 50 on the first discharged region R and the second discharged region Q so as to form a predetermined pattern. A temperature of the droplet discharge head 40 is controlled near the saturation temperature. The temperature controlling step is performed in the step S4 so that the temperature of the droplet discharge head 50 is controlled at the prediction temperature, which is near the saturation temperature. Thus, a temperature variation of the droplet discharge head 50 while performing the application step can be reduced. Therefore, a variation of the discharge amount of the droplet discharge head 50 due to a temperature variation can be also reduced. After performing the application step of the step S5, the discharge operation is completed. Additionally, in the application step, when the droplet discharge head 50 is in a stop status, that is the droplet discharge head 50 is opposed to the intervals g1 and g2 of the discharged region, the temperature adjustment step of the step S4 is also preferably performed.

Setting of Temperature Control Condition

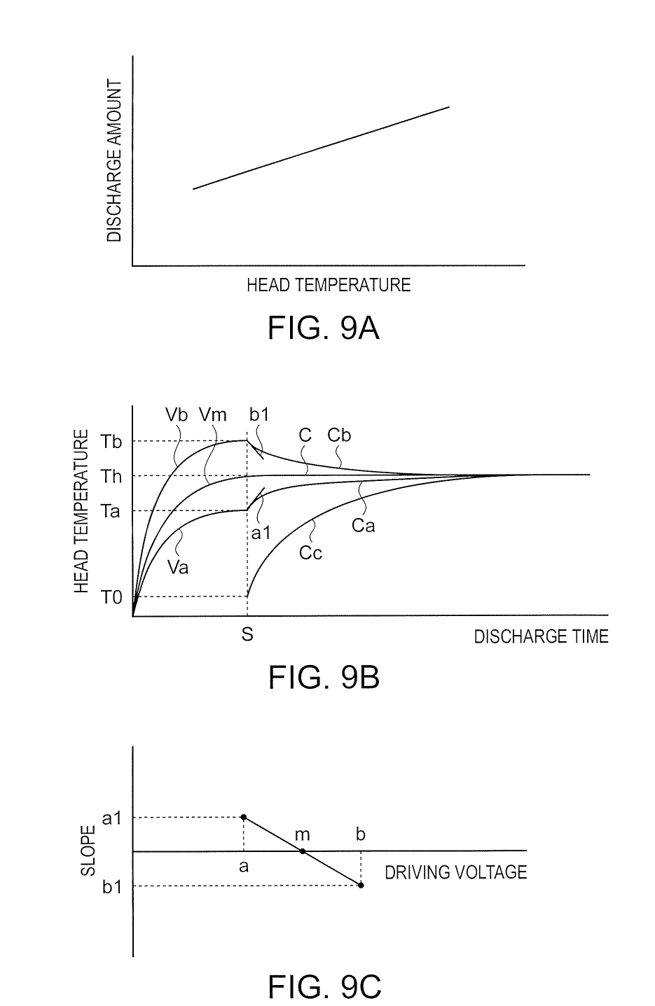

Next, a method for setting a temperature control condition (a driving condition) in the temperature adjustment step will be described with reference to FIGS. 9A, 9B, and 9C. FIGS. 9A, 9B and 9C are diagrams explaining the method for setting a temperature control condition. FIG. 9A is a graph showing a relation of a discharge amount of the droplet and a head temperature. FIG. 9B is a graph showing a relation of discharge time of the droplet and a head temperature. FIG. 9C is a graph showing a method for estimating a driving voltage that controls a temperature.

As described above, a viscosity of the droplet including a functional material discharged from the droplet discharge head 50 varies in accordance with a temperature variation. In the droplet discharge device 10, if a viscosity of the droplet varies, a flow path resistance in the droplet discharge head 50 varies. As a result, the discharge amount varies. That is, as shown in FIG. 9A, the discharge amount of the droplet discharge head 50 varies depending on a temperature of the droplet discharge head 50 (hereafter, refereed to as a head temperature T).

As a temperature curve Cc shown in FIG. 9B, the head temperature T (a temperature of the droplet discharge head 50 discharging the droplet) rises as discharge time passes from a discharge start point S, then becomes substantially stable near a saturation temperature Th of the droplet discharge head 50. In this case, it takes a long time for a temperature of the droplet discharge head 50 to become substantially stable at the saturation temperature Th. Therefore, as a temperature curve C shown in FIG. 9B, the head temperature T is preferably controlled near the saturation temperature Th in advance by the discharge start point S by supplying a driving voltage Vm of around a threshold size by which the droplet is not discharged. In addition, the driving voltage Vm is m % of a driving voltage V designed in which a proper discharge amount can be obtained.

Hereafter, a method for calculating the driving voltage Vm will be described. As a temperature curve Ca shown in FIG. 9B, a preheating driving (a temperature control) is performed with a driving voltage Va which is a % of the driving voltage V designed in which a proper discharge amount can be obtained so that the head temperature T rises and becomes a temperature Ta (Th>Ta) at the discharge start point S. After the discharge operation of the droplet is started, the head temperature T rises and becomes the saturation temperature Th, whereby the head temperature T becomes substantially stable. In addition, a slope of the temperature curve Ca at the discharge start point S is expressed as a slope a1.

Further, as a temperature curve Cb, a preheating driving (a temperature control) is performed with a driving voltage Vb which is b % of the driving voltage V designed in which a proper discharge amount can be obtained so that the head temperature T rises and becomes a temperature Tb (Tb>Th>Ta) at the discharge start point S. After the discharge operation of the droplet is started, the head temperature T lowers and becomes the saturation temperature Th, whereby the head temperature T becomes substantially stable. In addition, a slope of the temperature curve Cb at the discharge start point S is expressed as a slope b1.

In this time, a value of the driving voltage Vm is between Va and Vb. In other words, m is a value between a and b. As shown in FIG. 9C, a vertical axis showing a slope and a horizontal axis showing a percentage multiplied to the driving voltage V are set. Then, a straight line that passes through two plotted points, (a, a1) and (b, b1), is drawn. A point where the straight line intersects with the horizontal axis (a driving voltage), that is a value m where the slope becomes zero, is obtained. Then, a preheat driving (a temperature control) is performed with the driving voltage Vm obtained above. The driving voltage Vm is m % of the driving voltage V designed in which a proper discharge amount can be obtained. The temperature is thus controlled so that the head temperature T reaches near the saturation temperature Th in minimum time. In addition, the head temperature T is estimated to be near the saturation temperature Th at the discharge start point S.

However, a temperature that the head temperature T becomes substantially constant (a saturation temperature) differs according to the discharge ratio of the nozzle group 52b of each droplet discharge head 50. This seems due to a difference in heat capacity of the respective droplet discharge heads 50 or the respective the nozzle groups 52 in accordance with the amount of the droplet accumulating in the droplet discharge head 50 without being discharged and spreading of heat by a fluid of the droplet, for example. In order to improve accuracy of the temperature adjustment step described above, the driving voltage Vm is preferably fine-adjusted for each nozzle group 52 having a different discharge ratio corresponding to a pattern to be formed.

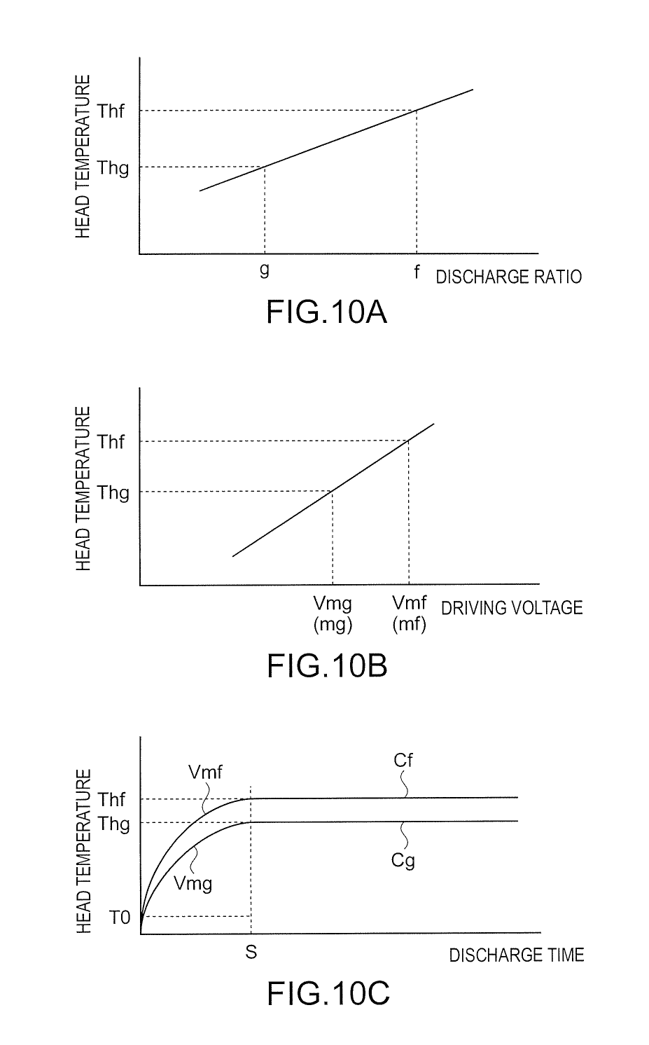

Hereafter, a method for fine-adjusting a driving voltage will be described with reference to FIGS. 7 and 10A, 10B, and 10C. FIGS. 10A, 10B and 10C are diagrams for explaining the method for fine-adjusting a driving voltage. FIG. 10A is a diagram showing a relation of the saturation temperature (a head temperature) and the discharge ratio. FIG. 10B is a diagram showing a relation of a driving voltage and a saturation temperature (a head temperature). FIG. 10C is a diagram showing a head temperature after controlling the temperature and discharge time.

The nozzle group 52b1 of the head R1 shown in FIG. 7 includes two intervals g2 within the discharge width L while the nozzle group 52b2 of the head R2 includes one interval g1 within the discharge width L. Accordingly, the number of discharge times of the nozzle group 52b1 is smaller than that of the nozzle group 52b2. In a single discharge operation in the main scanning direction, the nozzle group 52b2 discharges the droplet at a discharge ratio f while the nozzle group 52b1 discharges the droplet at a discharge ratio g (g<f).

As a result of experiment, the inventors found that a calorific value of the nozzle group 52b is substantially proportional to a discharge ratio (the number of the nozzles 52 driven per unit time), and a relation of the saturation temperature Th of the nozzle group 52b and the discharge ratio becomes an approximate straight line shown in FIG. 10A. That is, the saturation temperature Th is substantially proportional to the discharge ratio of the corresponding nozzle group 52b. Therefore, obtaining the discharge ratio allows calculating a saturation temperature Thb that the nozzle group 52b is expected to reach. According to FIG. 10A, the nozzle group 52b2 discharging the droplet at the discharge ratio f reaches to a saturation temperature Thf, and the nozzle group 52b1 discharging the droplet at a discharge ratio g reaches to a saturation temperature Thg.

Further, as shown in a graph of FIG. 10B, the head temperature T of the droplet discharge head 50 is substantially proportional to a value of the applied driving voltage V. Accordingly, the value of the driving voltage V that should be applied, that is a value of m multiplied to the driving voltage V, can be calculated from the head temperature T to be reached. According to FIG. 10B, a driving voltage Vmf is preferably applied to the nozzle group 52b2 that reaches to the saturation temperature Thf, and a driving voltage Vmg is preferably applied to the nozzle group 52b1 that reaches to the saturation temperature Thg.

That is, as shown in a temperature curve Cg shown in FIG. 10C, the driving voltage Vmg is applied to the nozzle group 52b1 of the discharge ratio g so as to control the temperature. The head temperature T is reached to the saturation temperature Thg at the discharge start point S, and becomes substantially stable so as to perform the discharge operation afterward. In addition, as shown in a temperature curve Cf, the driving voltage Vmf is applied to the nozzle group 52b2 of the discharge ratio f so as to control the temperature. The head temperature T is reached to the saturation temperature Thf at the discharge start point S, and becomes substantially stable so as to perform the discharge operation afterward.

Now, advantageous effects of the first embodiment will be described below.

The droplet discharge device 10 described above can obtain a discharge ratio of the nozzle group 52b when forming a predetermined pattern as information, calculate the head temperature Th that the nozzle group 52b reaches and the head temperature becomes substantially stable from the discharge ratio. Further, the driving voltage Vm controlling a temperature of the nozzle group 52b to the head temperature Th that a temperature of the nozzle group 52b becomes substantially stable can be obtained from the discharge ratio. Then, the driving voltage Vm controls the temperature of the nozzle group 52b so that the temperature of the nozzle group 52b can be reached to the head temperature Th. Accordingly, the temperature of the nozzle group 52b becomes substantially stable and a temperature variation can be reduced so as to reduce a variation of the discharge amount of the droplet. As a result, a variation of the amount of the droplet discharged on the workpiece W can be reduced, and unevenness and a variation of a thickness of a pattern to be formed can be reduced. Therefore, a pattern (a thin film) in which the unevenness and a variation are reduced can be formed.

The droplet discharge device 10 described above can obtain the head temperature Th and the driving voltage Vm for each nozzle group 52b corresponding to a pattern so as to control the temperature. The head temperature Th is where a temperature becomes substantially stable, and the driving voltage Vm makes the temperature to reach the head temperature Th in a short time. Therefore, with respect to a variety of different patterns, the droplet discharge device 10 can reduce a variation of the discharge amount of the droplet so as to form a pattern.

The droplet discharge device 10 described above can control the temperature of the nozzle group 52b by applying the driving voltage Vm of around a threshold size by which the droplet is not discharged from the nozzle group 52b. Therefore, since a particular temperature control unit is not necessary to be provided, the device can be downsized. In addition, the driving voltage Vm of around a threshold size by which the droplet is not discharged from the nozzle 52 is applied so as to vibrate the droplet in the droplet discharge head 50. As a result, an increase of a viscosity of the droplet accumulating in the droplet discharge head 50 can be reduced, and a meniscus of a droplet discharge orifice of the nozzle 52 can be optimally maintained.

The droplet discharge device 10 described above can control a temperature of the nozzle group 52b at the discharge start point S by applying the driving voltage Vm of around a threshold size by which the droplet is not discharged from the nozzle group 52b. Accordingly, the head temperature T can be controlled near the head temperature Th which is a substantially stable temperature from the beginning of the discharge operation. A possibility that head temperature T of the droplet discharge head 50 varies can be reduced.

### Second Embodiment

In the first embodiment described above, in the temperature adjustment condition set step of the step S3 shown in FIG. 8, corresponding to a discharge ratio of a pattern formed by the nozzle group 52b, an optimum driving voltage Vm is selected out of a plurality of the driving voltages Vm obtained and inputted in advance for each of a plurality of the discharge ratios and stored in the RAM 43 of the controller 4 so as to supply to the nozzle group 52b. However, it is not particularly limited to this.

By using the host computer 11 or the CPU 41 shown in FIG. 4, the head temperature Thb that the nozzle group 52b is expected to reach and become stable is calculated based on the discharge ratio of the nozzle group 52b from an approximation formula showing a relation of the head temperature Th and the discharge ratio shown in FIG. 10A. Further, a value of the driving voltage Vm that should be applied for reaching the head temperature Th, that is, a value of m multiplied to the driving voltage V designed in which a proper discharge amount can be obtained, is calculated from an approximation formula showing a relation of the head temperature Th and the driving voltage Vm shown in FIG. 10B. The obtained value may be supplied to the nozzle group 52b. The same beneficial effect of the first embodiment can be also obtained in this case.

### Third Embodiment

Next, a method for manufacturing a liquid crystal display as an electro-optical device using the droplet discharge device of the first or the second embodiment and the liquid crystal display manufactured by this method will be described.

Liquid Crystal Display

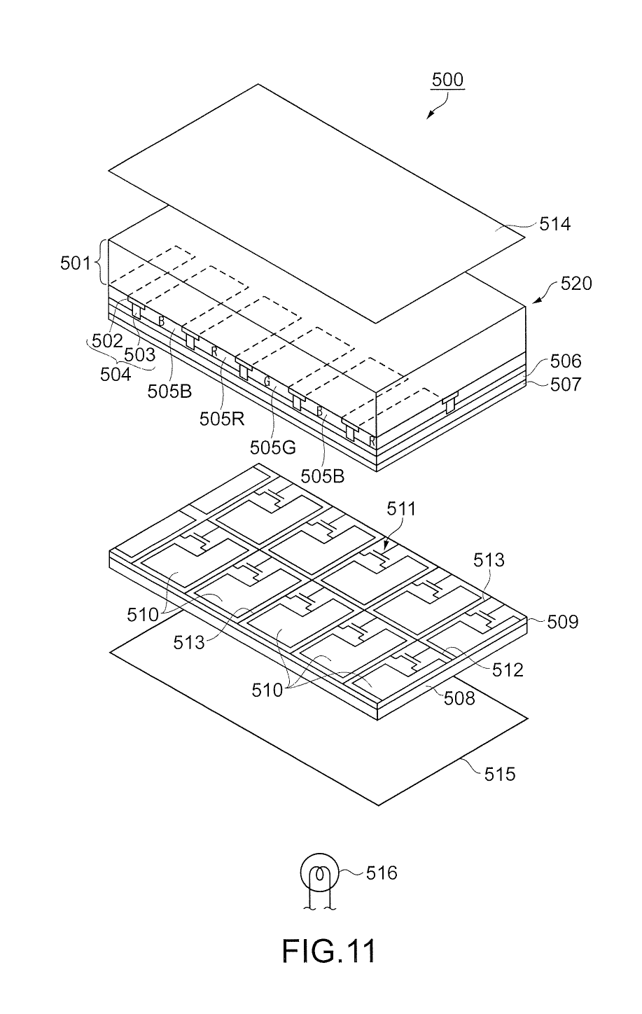

FIG. 11 is a perspective view schematically showing a structure of a liquid crystal display. As shown in FIG. 11, a liquid crystal display 500 of the embodiment includes a liquid crystal display panel 520 of a thin film transistor (TFT) transmissive type and an illumination device 516 illuminating the liquid crystal display panel 520. The liquid crystal display panel 520 includes a counter substrate 501 having a color filter as a color element, an element substrate 508 having TFT elements 511 one of three terminals of which is coupled to one of pixel electrodes 510, and liquid crystal (not shown) held between the both substrates 501 and 508. Further, on surfaces of the both substrates 501 and 508 forming outer surfaces of the liquid crystal display panel 520 includes an upper polarization plate 514 and a lower polarization plate 515 disposed thereon for polarizing light transmitted therethrough.

The counter substrate 501 is made of a transparent material such as glass, and has color filters 505R, 505G, and 505B of three colors RGB as a a plurality of kinds of color elements formed in a plurality of color element regions partitioned in a matrix with a partition 504 on a side of the surface holding the liquid crystal. The partition 504 is composed of a lower layer bank 502 called a black matrix and made of metal having a light shielding property such as Cr or an oxide film thereof, and an upper layer bank 503 made of an organic compound and formed on (downward in the drawing) the lower layer bank 502. Further, the counter substrate 501 includes an overcoat layer (an OC layer) 506 as a planarizing layer for covering the partition 504 and the color filters 505R, 505G, and 505B partitioned by the partition 504, and a counter electrode 507 made of a transparent conductive film such as indium tin oxide (ITO) formed to cover the OC layer 506. The color filters 505R, 505G, and 505B are manufactured by using a method for manufacturing a liquid crystal display described later.

The element substrate 508 is similarly made of a transparent material such as glass, and includes pixel electrodes 510 formed in a matrix on the side of the surface holding the liquid crystal with an insulating film 509 therebetween, and a plurality of TFT elements 511 formed corresponding to the pixel electrodes 510. Two terminals out of the three terminals of the TFT element 511, which are not coupled to the pixel electrode 510, are respectively coupled to a scanning line 512 and a data line 513 disposed so as to surround the pixel electrode 510 while being insulated from each other.

The illumination device 516 may be anything that uses white LED, white EL, or white cold-cathode tube as a light source and includes a structure of a light guide plate, a diffusing plate, reflecting plate, and the like that is capable of emitting the light from the light source towards the liquid crystal display panel 520.

The liquid crystal display panel 520 is not limited to the TFT element as an active element, but may be a thin film diode (TFD) element instead, and further, may be a passive-type liquid crystal display in which electrodes forming pixels are disposed so as to intersect with each other if at least one of substrates includes a color filter. Further, the upper and lower polarization plates 514 and 515 may be a combination with an optical functional film such as a retardation film used for a purpose of improving the view angle dependency.

Method for Manufacturing Liquid Crystal Display

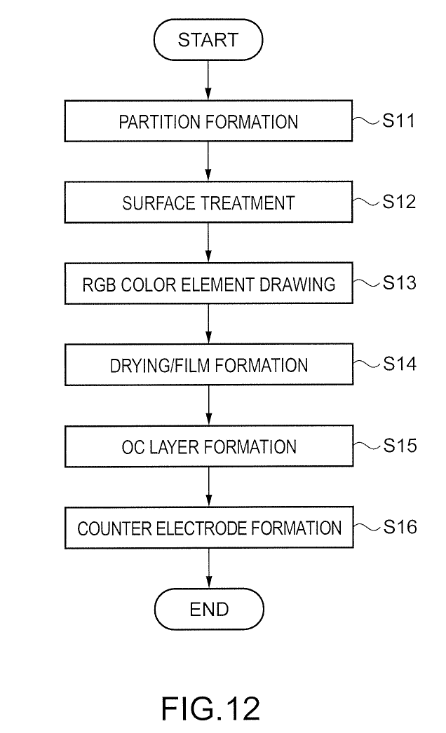

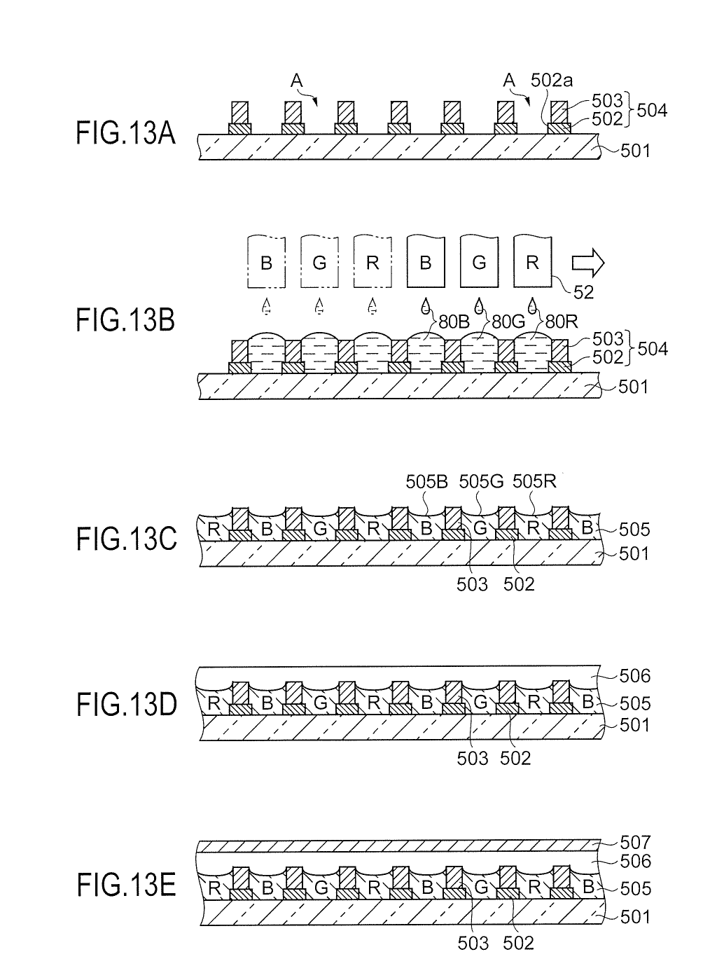

A method for manufacturing a liquid crystal display of the embodiment will be described with reference to FIGS. 12 and 13. FIG. 12 is a flowchart showing the method of manufacturing a liquid crystal display. FIGS. 13A to 13E are sectional views schematically showing the method for manufacturing a liquid crystal display.

As shown in FIG. 12, the method for manufacturing the liquid crystal display 500 of the embodiment includes a step of forming the partition 504 on a surface of the counter substrate 501 and a step of performing a surface treatment of the color element regions partitioned by the partition 504. The method further includes a color element drawing step in which three kinds (three colors) of liquid bodies including a color filter formation material as a color element formation material are applied on the surface treated color element regions by the droplet discharge device 10 of the first or the second embodiment so as to draw the color filter 505 and a film formation step in which the drawn color filter 505 are dried so as to form a film thereon. The method still furthermore includes a step for forming the OC layer 506 to cover the partition 504 and the color filter 505 and a step of forming the transparent counter electrode 507 made of ITO to cover the OC layer 506.

A step S11 of FIG. 12 is a step of forming the partition 504. In the step S11, as shown in FIG. 13A, first, the lower layer bank 502 as a black matrix is formed on the counter substrate 501. The lower layer bank 502 may be made of opaque metal such as Cr, Ni or Al, or a compound such as an oxide of these metals, for example. In order to form the lower layer bank 502, a film made of any one of the above materials is formed on the counter substrate 501 by a vapor deposition method or a sputtering method. A thickness of the film may be determined according to a selected material so that light shielding is maintained. For example, if the lower layer bank 502 is made of Cr, a preferable film thickness ranges from 100 nm to 200 nm. Then, using a photolithography method, the film excluding a part corresponding to opening 502a is covered with a resist and then etched with an etching solution such as an acid corresponding to the material above. Accordingly, the lower layer bank 502 including the opening 502a can be formed.

Next, the upper layer bank 503 is formed on the lower layer bank 502. As a material of the upper layer bank 503, an acrylic photosensitive resin can be used. In addition, the photosensitive resin is preferably a light shielding material. In order to form the upper layer bank 503, for example, the photosensitive resin is applied on the surface of the counter substrate 501 on which the lower layer bank 502 is formed by a roll coating method or the sputtering method. Next, by drying the applied material, a photosensitive resin layer having a thickness of approximately 2 μm is formed. Next, a mask having an opening with a size corresponding to that of each color element A is opposed to the counter substrate 501 at a predetermined position. Then, through exposure and development, the upper layer bank 503 is formed. Accordingly, the partition 504 partitioning the plurality of the color element regions A in a matrix is formed on the counter substrate 501. Then, the step goes to a step S12.

The step S12 of FIG. 12 is a surface treatment step. In the step S12, a plasma treatment using O₂ as a treatment gas and a plasma treatment using a fluoric gas as a treatment gas are performed. That is, the color element region A is lyophilic treated and thereafter, a surface (including a wall surface) of the upper layer bank 503 made of the photosensitive resin is repellent treated. Then, the step goes to a step S13.

The step S13 of FIG. 12 is a drawing step of the color filter as a color element. In the step S13, as shown in FIG. 13B, on each of the surface treated color element regions A, corresponding liquid bodies 80R, 80G or 80B are applied so as to draw the color filter 505. The liquid 80R includes an R (red) color filter formation material, the liquid 80G includes a G (green) color filter formation material, and the liquid 80B includes a B (blue) color film formation material. In order to apply each of the liquid bodies 80R, 80G and 80B, by using the droplet discharge device 10 of the first or the second embodiment, each of the liquid bodies 80R, 80G and 80B are filled in the droplet discharge heads 50 to be landed as a droplet on each of the color element regions A. Each of the liquid bodies 80R, 80G and 80B is applied a required amount corresponding to an area of each color element region A. The applied droplet spreads to wet each color element region A and is raised by surface tension. Then, the step goes to a step S14.

The step S14 of FIG. 12 is a step of forming a film by drying the drawn color filter 505. In the step S14, as shown in FIG. 13C, the discharged and drawn color filters 505 are dried all together to remove a solvent component from each of the liquid bodies 80R, 80G, and 80B so as to form color filters 505R, 505G and 505B as a film. The drying is preferably performed under reduced pressure so that the solvent component can be evenly dried. Then, the step goes to a step S15.

The step S15 of FIG. 12 is an OC layer formation step. In the step S15, as shown in FIG. 13D, the OC layer 506 is formed so as to cover the color filter 505 and the upper layer bank 503. As a material of the OC layer 506, a transparent acryl resin may be used. The OC layer is formed by a spin coating method, an offset lithography, and the like. The OC layer 506 is disposed to reduce unevenness of the surface of the counter substrate 501 on which the color filters 505 formed to even the counter electrode 507 which is film-formed on the surface thereof later. Furthermore, in order to ensure adhesion with the counter electrode 507, a thin film made of SiO₂ and the like may be additionally formed on the OC layer 506. Then, the step goes to a step S16.

The step S16 of FIG. 12 is a step of forming the counter electrode 507. In the step S16, as shown in FIG. 13E, by using the sputtering method or a vapor deposition method, a film made of a transparent electrode material such as ITO is formed in a vacuum, whereby the counter electrode 507 is formed on the entire surface of the OC layer 506 in a covering manner.

The counter substrate 501 thus formed and the element substrate 508 having the pixel electrodes 510 and the TFT elements 511 are bonded together at a predetermined position by an adhesive, and liquid crystal is filled between both substrates 501 and 508. As a result, the liquid crystal display 500 is obtained.

Now, advantageous effects of the third embodiment will be described below.

In the method for manufacturing the liquid crystal display 500, in the color element drawing step, the three kinds of liquid bodies 80R, 80G, and 80G are discharged by the droplet discharge device 10 of the first or the second embodiment on the color element regions A of the counter substrate 501 of the liquid crystal display panel 520 so as to form the color filters 505R, 505G, and 505B as three kinds of color elements. At this time, the droplet discharge head 50 can discharge the three kinds of liquid bodies 80R, 80G, and 80B in a state such that a temperature of the nozzle group 52b is substantially stable corresponding to a pattern to be formed and a temperature variation is reduced. Accordingly, a variation of the discharge amount of the three kinds of liquid bodies 80R, 80G, and 80B is reduced so as to reduce a variation of the amount of the liquid bodies discharged to the color element regions A. Further, unevenness and a variation of a thickness of the color filters 505R, 505G, and 505B to be formed can be reduced. As a result, the color filter 505 of which unevenness and a variation is reduced can be formed.

The liquid crystal display 500 includes the counter substrate 501 having the color filters 505 obtained by the above manufacturing method for the liquid crystal display 500. Accordingly, the liquid crystal display 500 having less color variation and the like due to unevenness and a variation of a film thickness and a high visual display quality can be provided.

### Fourth Embodiment

Next, a method for manufacturing an organic EL display as an electro-optical device using the droplet discharge device of the first or the second embodiment and the organic EL display manufactured by this method will be described.

Organic EL Display

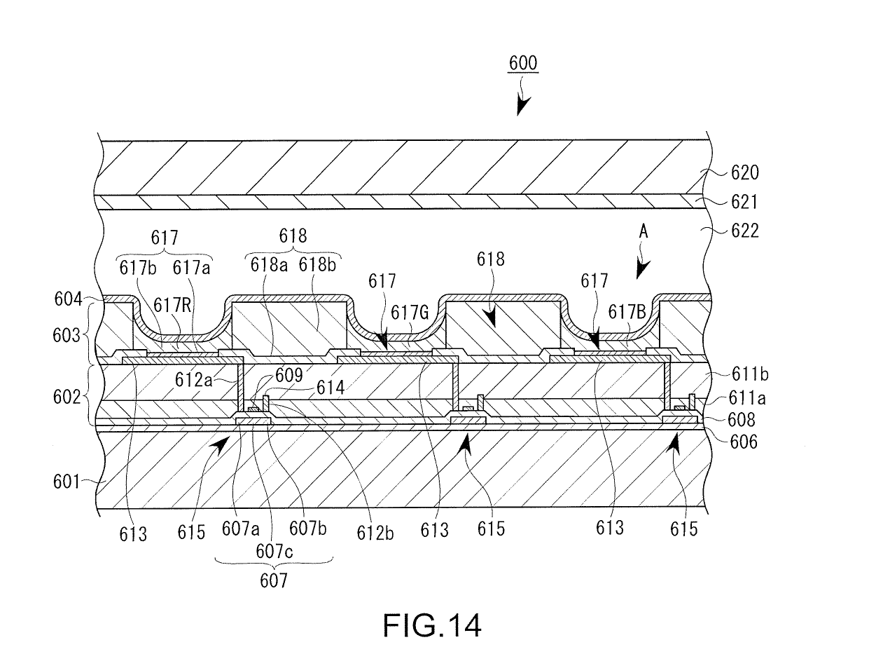

FIG. 14 is a sectional view schematically showing a structure of an essential part of the organic EL display. As shown in FIG. 14, an organic EL display 600 as an electro-optical device of the embodiment includes an element substrate 601 having a light emitting element section 603 and a seal substrate 620 sealingly bonded to the element substrate 601 with a space 622 therebetween. Additionally, the element substrate 601 includes a circuit element section 602 provided thereon. The light emitting element section 603 is formed on the circuit element section 602 in a superposed manner to be driven by the circuit element section 602. In the light emitting element section 603, three colors of light emitting layers 617R, 617G, and 617B are formed in their respective color element regions A to be arranged in a stripe. On the element substrate 601, three color element regions A corresponding to the three colors of the light emitting layers 617R, 617G and 617B are designated as a set of picture elements. The picture elements are arranged in a matrix on the circuit element section 602 of the element substrate 601. In the organic EL display 600 of the embodiment, light emitted from the light emitting element section 603 is outputted to the element substrate 601.

The seal substrate 620 is made of glass or metal, and bonded to the element substrate 601 with a sealing resin therebetween. On a sealed inner surface thereof, a getter agent 621 is attached. The getter agent 621 absorbs water or oxygen entering the space 622 between the element substrate 601 and the seal substrate 620 to protect the light emitting element section 603 from being deteriorated by the water or the oxygen entered thereto. However, the getter agent 621 may be omitted.

The element substrate 601 of the embodiment has the plurality of the color element regions A on the circuit element section 602, and includes banks 618 as a partition partitioning the color element regions A, electrodes 613 formed on the color element regions A, and hole injection/transport layers 617a laminated on the electrodes 613. Additionally, the element substrate 601 includes the light emitting element section 603 having the light emitting layers 617R, 617G and 617B formed by applying three kinds of liquid bodies including a light emitting layer formation material in the plurality of the color element regions A. The bank 618 includes a lower layer bank 618a and an upper layer bank 618b substantially partitioning the color element regions A. The lower layer bank 618a is disposed in a projecting manner inside the color element region A and made of an inorganic insulating material such as SiO₂ so as to prevent electric short caused by direct contact of the electrode 613 with each of the light emitting layers 617R, 617G and 617B.

The element substrate 601 is made of a transparent substrate such as glass, for example. On the element substrate 601, a base protection film 606 made of a silicon oxide film is formed. Further, on the base protection film 606, an island-like semiconductor film 607 made of polysilicon is formed. On the semiconductor film 607, a source region 607a and a drain region 607b are formed by a P-ion implantation in high concentration. A region where no P is ion implanted is referred to as a channel region 607c. Additionally, a transparent gate insulation film 608 covering the base protection film 606 and the semiconductor film 607 is formed. On the gate insulation film 608, a gate electrode 609 made of Al, Mo, Ta, Ti, W and the like is formed. On the gate electrode 609 and the gate insulation film 608, transparent first and second interlayer insulation films 611a and 611b are formed. The gate electrode 609 is disposed at a position corresponding to the channel region 607c of the semiconductor film 607. Furthermore, contact holes 612a and 612b penetrating through the first and the second interlayer insulation films 611a and 611b to be respectively coupled to the source region 607a and the drain region 607b of the semiconductor film 607 are formed. On the second interlayer insulation film 611b, the electrode 613 which is transparent and made of ITO is patterned into a predetermined shape (an electrode formation step). One of contact holes, the contact hole 612a, is coupled to the electrode 613. On the other hand, another contact hole, the contact hole 612b, is coupled to the power supply line 614. In this manner, in the circuit element section 602, a driving thin film transistor 615 coupled to each electrode 613 is formed. In addition, the circuit element section 602 includes a storage capacitor and a switching thin film transistor. However, they are not shown in FIG. 14.

The light emitting element section 603 includes the electrodes 613 as a positive electrode, the hole injection/transport layers 617a, each of the light emitting layers 617R, 617G and 617B (generally referred to as a light emitting layer 617b) sequentially laminated on the electrodes 613, and a negative electrode 604 laminated to cover the upper layer bank 618b and the light emitting layer 617b. In addition, if the negative electrode 604, the seal substrate 620, and the getter agent 621 are made of a transparent material, emitted light can be output from the seal substrate 620 side.

The organic EL display 600 has a scanning line (not shown) coupled to the gate electrode 609 and a signal line (not shown) coupled to the source region 607a. When the switching thin film transistor (not shown) is turned on by a scanning signal transmitted to the scanning line, a potential of the signal line at that time is retained by the storage capacitor. Then, according to a state of the storage capacitor, the driving thin film transistor 615 is turned on or off. Then, a current flows from the power supply line 614 to the electrode 613 through the channel region 607c of the driving thin film transistor 615, and then, flows into the negative electrode 604 through the hole injection/transport layer 617a and the light emitting layer 617b. The light emitting layer 617b emits light according to an amount of the current flowing thereinto. The organic EL display 600 allows desired characters, images, and the like to be displayed due to such a light emitting mechanism of the light emitting element section 603. In addition, the light emitting layer 617b is formed by drawing with the droplet discharge device 10. Thus, the display has high display quality with reduced display failures such as variations of light emission and luminance due to uneven distribution of discharged droplet occurring at a drawing operation.

Method for Manufacturing Organic EL Display

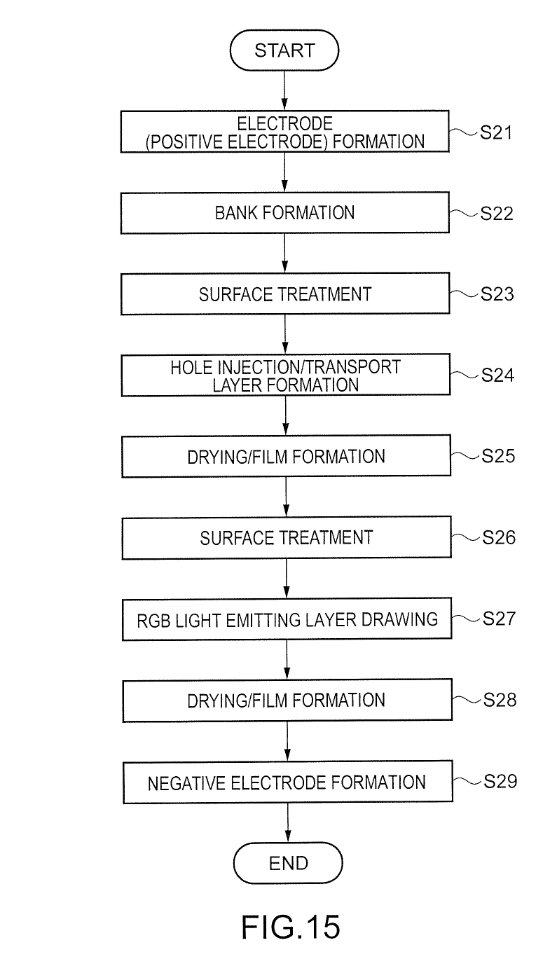

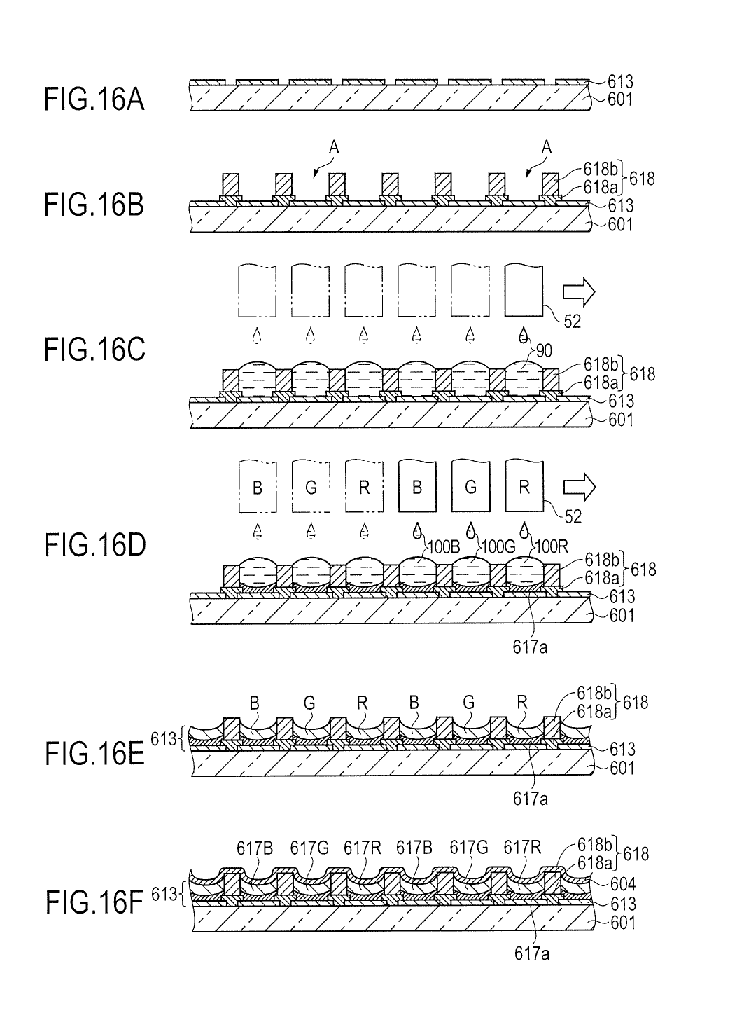

Next, a method for manufacturing an organic EL display of the embodiment will be described with reference to FIGS. 15 and 16A to 16F. FIG. 15 is a flowchart showing the method for manufacturing an organic EL display. FIGS. 16A to 16E are sectional views schematically showing the method for manufacturing an organic EL display. In FIGS. 16A to 16F, the circuit element section 602 formed on the element substrate 601 is not shown.

As shown in FIG. 15, the method for manufacturing an organic EL display includes a step of forming the electrode 613 at a position corresponding to the plurality of the color element regions A on the element substrate 601 and a bank (partition) formation step in which the lower layer bank 618a is formed such that a part thereof is extended on the electrode 613 with a part thereof and then the upper layer bank 618b is formed on the lower layer bank 618a so as to substantially partition the color element regions A. Additionally, the above method includes a step of performing a surface treatment of the color element regions A partitioned by the upper layer bank 618b, a step of performing discharging/drawing the hole injection/transport layer 617a by applying a droplet including a hole injection/transport layer material on each of the surface-treated color element regions A, and a step of drying the discharged droplet to form a film of the hole injection/transport layer 617a. The above method also includes a step of performing a surface treatment of the color element regions A on which the hole injection/transport layer 617a is formed, a light emitting layer drawing step in which the light emitting layer 617b is discharged/drawn as a color element drawing step by applying three kinds of liquid bodies including a light emitting formation material as a color element formation material on the surface treated color element regions A, and a step of drying the discharged three kinds of the liquid bodies to form a film of the light emitting layer 617b. Further, the above method includes a step of forming the negative electrode 604 to cover the upper bank 618b and the light emitting layer 617b. Each droplet is applied on each color element region A by using the droplet discharge device 10.

A step S21 of FIG. 15 is an electrode (a positive electrode) formation step. In the step 21, as shown in FIG. 16A, the electrode 613 is formed at a position corresponding to each color element region A on the element substrate 601 on which the circuit element section 602 is formed. As a formation method, for example, on a surface of the element substrate 601, a transparent electrode film made of a transparent electrode material such as ITO is formed by the sputtering method or the vapor deposition method in a vacuum. Thereafter, while leaving only a necessary part, etching is performed by the photolithography method to form the electrode 613. In addition, the element substrate 601 is covered first by the photolithography method. Then, through exposure and development, a region forming the electrode 613 is opened. A method that forms a transparent electrode film made of ITO and the like formed at an opening to remove the remaining photoresist may be employed. Then, the step goes to a step S22.

The step S22 of FIG. 15 is a bank (a partition) formation step. In the step S22, as shown in FIG. 16B, the lower layer bank 618a is formed so as to cover part of the plurality of the electrodes 613 on the element substrate 601. The lower layer bank 618a is made of SiO₂ (silicon dioxide) that is an organic insulation material. In order to form the lower layer bank 618a, for example, in accordance with the light emitting layer 617b to be formed later, a masking of the surface of each electrode 613 is performed by using a resist and the like. Next, the masked element substrate 601 is put in a vacuum device to perform the sputtering or a vacuum deposition using SiO₂ as a target or a raw material, thereby the lower layer bank 618a is formed. The mask made of the resist and the like is peeled off later. Additionally, since the lower layer bank 618a is made of SiO₂, if the film thickness is 200 nm or less, it has a sufficient transparency. Thus, although the hole injection/transport layer 617a and the light emitting layer 617b are laminated later, light emission is not inhibited.

Next, the upper layer bank 618b is formed on the lower layer bank 618a such that each color element region A is substantially partitioned. Preferably, the upper layer bank 618b is made of a material that is durable against the solvents of three kinds of liquid bodies 100R, 100G and 100B including a light emitting layer formation material described later. More preferably, the upper layer bank 618b is made of a material which can be made tetrafluoroethylene by the plasma treatment using a fluoric gas as a treatment gas, for example, an organic material such as an acryl resin, an epoxy resin or a photosensitive polyimide. In order to form the upper layer bank 618b, for example, the photosensitive organic material is applied by the roll coating method or a spin coating method on the surface of the element substrate 601 on which the lower layer bank 618a is formed, and is dried so as to form a photosensitive resin layer having a thickness of approximately 2 μm. Then, a mask including the opening having a size corresponding to that of each color element region A is opposed to the element substrate 601 at a predetermined position. Then, through exposure and development, the upper layer bank 618b is formed. Accordingly, the bank 618 as a partition that includes the lower layer bank 618a and the upper layer bank 618b is formed. Then, the step goes to a step S23.

The step S23 of FIG. 15 is a step of performing a surface treatment for the color element region A. In the step S23, the surface of the element substrate 601 on which the bank 618 is formed is plasma treated by using an O₂ gas as a treatment gas. Thereby, the surface of the electrode 613, the projected part of the lower layer bank 618a, and the surface (including the wall surface) of the upper layer bank 618b are activated and lyophilically treated. Next, the surface of the element substrate 601 is plasma treated by using a fluoric gas such as CF₄ as a treatment gas. Thereby, the fluoric gas reacts only with the surface of the upper layer bank 618b made of the photosensitive resin which is an organic material. As a result, the surface of the upper layer bank 618b is lyophilically treated. Next, the step goes to a step S24.

The step S24 of FIG. 15 is a hole injection/transport layer formation step. In the step S24, as shown in FIG. 16C, a droplet 90 including a hole injection/transport layer formation material is applied on each color element region A. The droplet 90 is applied by using the droplet discharge device 10 of the first or the second embodiment. The droplet 90 discharged from the nozzle 52 of the droplet discharge head 50 is landed as a droplet on the electrode 613 of the element substrate 601 and spreads to wet the surface. The required amount of the droplet 90 corresponding to an area of each color element region A is discharged as a droplet, and is brought into a state of being raised by surface tension. Since one kind of the droplet 90 is discharged and drawn by the droplet discharge device 10, the discharge/drawing can be performed in at least a single main scanning. Then, the step goes to a step S25.

The step S25 in FIG. 15 is a drying and film formation step. In the step S25, the element substrate 601 is heated, for example, by a lamp annealing method to dry and remove a solvent component of the droplet 90, whereby the hole injection/transport layer 617a is formed in a region partitioned by the lower layer bank 618a of the electrode 613. In the embodiment, the hole injection/transport layer is made of polyethylene dioxy thiophene (PEDOT). In this case, the hole injection/transport layer 617a made of the same material is formed in each color element region A. However, in accordance with the light emitting layer to be formed later, the hole injection/transport layer 617a made of a different material may be formed in each color element region A. Then, the step goes to a step S26.

The step S26 of FIG. 15 is a step of performing a surface treatment for the element substrate 601 on which the hole injection/transport layer 617a is formed. In the step S26, if f the hole injection/transport layer 617a is made of the above hole injection/transport layer formation material, its surface is lyophobic to the three kinds of liquid bodies 100R, 100G, and 100G to be used in the following step, a step S27. Thus, the surface treatment is performed so that at least in the region of the color element region A becomes lyophilic again. For the surface treatment, a solvent used in the three kinds of the liquid bodies 100R, 100G and 100B is applied and dried. The solvent is applied by a spraying method, the spin coating method, and the like. Then, the step goes to a step S27.

The step S27 of FIG. 15 is an RGB light emitting layer drawing step. In the step S27, as shown in FIG. 16D, by using the droplet discharge device 10, the three kinds of the liquid bodies 100R, 100G and 100B including a light emitting layer formation material are applied to the plurality of the color element regions A from the nozzle 52 of the different droplet discharge head 50. The liquid 100R includes a material for forming the light emitting layer 617R (red), the liquid 100G includes a material for forming the light emitting layer 617G (green), and the liquid 100B includes a material for forming the light emitting layer 617B (blue). Each of the landed liquid bodies 100R, 100G, and 100B spreads to wet the surface of the color element region A, and a sectional shape of the droplet is raised in an arc. Then, the step goes to a step S28.

The step S28 in FIG. 15 is a drying and film formation step. In the step S28, as shown in FIG. 16E, a solvent component of each discharged/drawn droplet 100R, 100G, and 100B is dried and removed, and film formation is performed such that each light emitting layer 617R, 617G and 617B is laminated on the hole injection/ transport layer 617a of each color element region A. In order to dry the element substrate 601 on which each the droplet 100R, 100G, and 100B is discharged/drawn, the drying is preferably performed under reduced pressure which allows an evaporation speed of the solvent to be approximately constant. Then, the step goes to a step 29.

The step S29 of FIG. 15 is a negative electrode formation step. In the step S29, as shown in FIG. 16F, the negative electrode 604 is formed so as to cover each light emitting layer 617R, 617G and 617B on the element substrate 601 and the surface of the upper layer bank 618b. Preferably, the negative electrode 604 is made of a combination of materials such as Ca, Ba and Al and a fluoride such as LiF. In particular, a film made of Ca, Ba or LiF having a small work function is preferably formed on a side near the light emitting layer whereas a film made of Al and the like having a large work function is formed on a side distant therefrom. In addition, a protection layer made of SiO₂, SiN, and the like may be laminated on the negative electrode 604. This can prevent the negative electrode 604 from being oxidized. The negative electrode 604 may be formed by the evaporation method, the sputtering method, a chemical vapor deposition (CVD), and the like. Among them, the evaporation method is preferable since it can prevent the negative electrode from being damaged due to heat of the light emitting layer. By using thus formed element substrate 601, the organic EL display 600 is manufactured.

Now, advantageous effects of the fourth embodiment will be described below.

In the method for manufacturing the organic EL display 600, in the light emitting layer drawing step, the three kinds of liquid bodies 100R, 100G, and 100G are discharged by the droplet discharge device 10 of the first or the second embodiment on each color element region A of the element substrate 601 on which the hole injection/transport layer 617a is formed so as to form the light emitting layers 617R, 617G, and 617B as three kinds of color elements. At this time, the droplet discharge head 50 can discharge the three kinds of liquid bodies 100R, 100G, and 100B in a state such that a temperature of the nozzle group 52b is substantially stable corresponding to a pattern to be formed and a temperature variation is reduced. Accordingly, a variation of a discharge amount of the three kinds of liquid bodies 100R, 100G, and 100B is reduced, whereby a variation of an amount of the droplet discharged on the color element region A can be reduced. Further, unevenness and a variation of a thickness of the light emitting layers 617R, 617G, and 617B to be formed can be reduced. As a result, the light emitting layer 617b of which unevenness and a variation is reduced can be formed.

The organic EL display 600 includes the element substrate 601 having the light emitting layer 617b obtained by the method for manufacturing the organic EL display 600 above. Accordingly, the organic EL display 600 having reduced variations of light emission and luminance and the like due to unevenness and a variation of a film thickness and high visual display quality can be provided.

The embodiments of the invention are described hereinabove, and the embodiments can be modified in various manners within the scope of the invention. The modifications other than the embodiments described above, for example, are as follows.

Modification 1

In the above embodiments, a temperature of the nozzle group 52b is controlled at the time the droplet discharge head 50 starts a discharge operation on the workpiece W. However, it is not particularly limited to this. In the application step, when the droplet discharge head 50 is in a stop status, that is the droplet discharge head 50 is opposed to the intervals g1 and g2 of the discharged region, for example, the temperature of the nozzle group 52b is also preferably controlled. Thus, a temperature variation of the droplet discharge head 50 during the application step can be reduced.

Modification 2

In the above embodiments, the droplet is discharged from the droplet discharge head 50 on the workpiece W having a plurality of patterns in different size as shown in FIG. 7. However, it is not particularly limited to this. Any pattern to be formed may be applicable. A discharge ratio of the nozzle group 52b is calculated corresponding to the pattern to be formed. Then, based on the discharge ratio, a condition for controlling a temperature is set.

Modification 3

In the above embodiments, as the nozzle group 52b, the plurality of the nozzles 52 having the flow path 57 shown in FIG. 2 in common, that is the plurality of the nozzles 52 composing the nozzle line 52a, is described as an example. However, it is not particularly limited to this. It may be a group of the nozzles 52 that can be temporary driven and controlled. Additionally, it can be the individual nozzle 52.

Modification 4

In the above embodiments, as a workload, a discharge ratio which is the number of discharge times per unit time is used as an example. However, it is not particularly limited to this. For example, the number of times of applying a driving signal to the piezo element 59 can be included as a workload for reducing an increase of a viscosity of the droplet accumulating in the cavity 55 shown in FIG. 2, or optimally maintaining a meniscus of a droplet discharge orifice of the nozzle 52.

The entire disclosure of Japanese Patent Application No. 2008-146675, filed Jun. 4, 2008 is expressly incorporated by reference herein.

1. A droplet discharge device, comprising:
a discharge unit discharging a droplet;
an information obtaining unit obtaining workload information of the discharge unit while a predetermined pattern is formed on a discharged object;
a temperature calculation unit calculating a prediction temperature of the discharge unit while the pattern is formed based on the workload information obtained by the information obtaining unit; and
a temperature control unit controlling a temperature of the discharge unit at the prediction temperature calculated by the temperature calculation unit, wherein the discharge unit and the discharged object of the droplet are relatively moved so as to form the predetermined pattern on the discharged object.

2. The droplet discharge device according to claim 1, wherein the discharge unit includes a nozzle group discharging the droplet by an electrical driving signal and the temperature calculation unit calculates a substantially constant temperature that a temperature of the nozzle group reaches by discharging the droplet.

3. The droplet discharge device according to claim 1, wherein the information obtaining unit obtains at least a discharge ratio at which the droplet is discharged from a nozzle group as information, wherein the discharged object on which the pattern is formed and the nozzle group are relatively moved.

4. The droplet discharge device according to claim 1, wherein the temperature control unit is a driving control unit controlling a driving signal by which the droplet is discharged, and the driving signal of around a threshold size by which the droplet is not discharged from a nozzle group is supplied to the nozzle group so as to control a temperature of the nozzle group that discharges the droplet.

5. The droplet discharge device according to claim 1, wherein the temperature control unit includes a memory unit storing a plurality of driving signals corresponding to a discharge ratio of the pattern, and based on obtained information of the pattern, the driving signal corresponding to the pattern stored in the memory unit is selected and supplied to a nozzle group, wherein the droplet is discharged by the driving signal, and the discharge ratio is a ratio at which the droplet is discharged from the nozzle group.

6. The droplet discharge device according to claim 1, wherein the temperature control unit performs a calculation based on an obtained discharge ratio of the pattern so that a driving signal corresponding to the pattern is generated and supplied to a nozzle group, wherein the discharge ratio is a ratio at which the droplet is discharged from the nozzle group, and the driving signal by which the droplet is discharged.

7. The droplet discharge device according to claim 1, wherein the temperature control unit controls a temperature of a nozzle group while the droplet is not discharged from the nozzle group.

8. The droplet discharge device according to claim 1, wherein the temperature control unit controls a temperature of a nozzle group before the droplet is started to be discharged from the nozzle group on the discharged object.

9. A method for discharging a droplet in which a discharge unit discharging a droplet and a discharged object of the droplet are relatively moved so as to form a predetermined pattern on the discharged object, comprising:
obtaining workload information of the discharge unit while the pattern is formed;
calculating a prediction temperature of the discharge unit while the pattern is formed based on the obtained workload information obtained in the step of obtaining workload information; and
controlling a temperature of the discharge unit at the prediction temperature calculated in the step of calculating a temperature.

10. The method for discharging a droplet according to claim 9, wherein the discharge unit includes a nozzle group discharging the droplet by an electrical driving signal, and in the step of calculating a temperature, a saturation temperature that a temperature of the nozzle group becomes a substantially constant by discharging the droplet is calculated as a prediction temperature.

11. The method for discharging a droplet according to claim 9, wherein in the step of obtaining information, the discharged object on which the pattern is formed and a nozzle group are relatively moved, at least a discharge ratio at which the droplet is discharged from the nozzle group is obtained as information.

12. The method for discharging a droplet according to claim 9, wherein in the step of controlling a temperature includes controlling a driving signal, and in the step of controlling a driving signal, the driving signal of around a threshold size by which the droplet is not discharged from a nozzle group is supplied to the nozzle group, wherein the droplet is discharged by the driving signal from the nozzle group.

13. The method for discharging a droplet according to claim 9, wherein in the step of controlling a temperature includes a memory unit storing a plurality of driving signals corresponding to a discharge ratio of the pattern, and the driving signal corresponding to the pattern stored in the memory unit is selected and supplied to the nozzle group, wherein the droplet is discharged by the driving signal, and the discharge ratio is a ratio at which the droplet is discharged from the nozzle group.

14. The method for discharging a droplet according to claim 9, wherein in the step of controlling a driving signal, based on an obtained discharge ratio of the pattern, a calculation is performed so as to generate the driving signal corresponding to the pattern, and in the step of controlling a temperature, the driving signal generated in the step of controlling a driving signal is supplied to a nozzle group, wherein the droplet is discharged by the driving signal, and the discharge ratio is a ratio at which the droplet is discharged from the nozzle group.

15. The method for discharging a droplet according to claim 9, wherein in the step of controlling a temperature, a temperature of a nozzle group is controlled while the droplet is not discharged from the nozzle group.

16. The method for discharging a droplet according to claim 9, wherein in the step of controlling a temperature, a temperature of a nozzle group is controlled before the droplet is started to be discharged from the nozzle group on the discharged object.

17. A method for manufacturing an electro-optical device including an electro-optical panel having a plurality of color element regions partitioned by a partition disposed on at least one of substrates, comprising:
discharging a plurality of kinds of liquid bodies including a color element region formation material on the plurality of the color element regions on the one of the substrates by the method for discharging a droplet according to claim 9; and
drying the drawn color element to form a film.
